(19) United States
(12) Patent Application Publication
(10) Pub. No.: US 2025/0150120 A1
(43) Pub. Date: May 8, 2025

(54) SUB-SLOT PRECODING FOR WIRELESS COMMUNICATIONS

(71) Applicant: QUALCOMM Incorporated, San Diego, CA (US)

(72) Inventors: David YUNUSOV, Holon (IL); Gideon Shlomo KUTZ, Ramat Hasharon (IL); Amit BAR-OR TILLINGER, Tel-Aviv (IL)

(21) Appl. No.: 18/500,877

(22) Filed: Nov. 2, 2023

(51) Int. Cl. H04B 7/0452; H04B 7/0417; H04B 7/06

(52) U.S. Cl. CPC H04B 7/0452; H04B 7/0417; H04B 7/0628

(57) ABSTRACT

Methods, systems, and devices for wireless communications are described. A network entity may transmit one or more reference signals to a user equipment (UE). The network entity may receive, from the UE, channel estimation information based on the reference signals and observed channel conditions for the UE during a first time slot. The network entity may determine, based on the received channel estimation information, a first channel condition prediction associated with a first sub-slot of a second time slot and a second channel condition prediction associated with a second sub-slot of the second time slot. The network entity may determine multiple precoders based on the channel condition predictions. The network entity may communicate with the UE using a first precoder during the first sub-slot of the second time slot and a second precoder during the second sub-slot of the second time slot.

### FIELD OF TECHNOLOGY

The following relates to wireless communication, including sub-slot precoding for wireless communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

In some examples of wireless communications, one or more devices may operate in accordance with multi-user multi-input/multi-output (MU-MIMO) communications. MU-MIMO communications may be based on updating a precoding matrix at the network entity using information of a channel from each network entity transmission antenna (or antenna port) to each UE reception antenna (or antenna port). The network entity may periodically transmit channel state information reference signals (CSI-RSs) and receive the information of the channel via sounding reference signals (SRSs) based on feedback from each UE in response to the CSI-RSs. In some cases, however, the periodicity of transmitting CSI-RS and SRS may occur every several slots. As such, if the set of UEs are operating in a high mobility environment, the precoding matrix may become outdated in between reference signal transmissions, which may degrade spatial separation and orthogonality of data channels between the set of UEs.

The described techniques relate to improved methods, systems, devices, and apparatuses that support sub-slot precoding for wireless communications. For example, the described techniques provide for a method by a first wireless device. The method may include transmitting one or more reference signals to a second wireless device, receiving, from the second wireless device, in response to the one or more reference signals, channel estimation information that is associated with observed channel conditions for the second wireless device during a first time slot, determining, based on the received channel estimation information, multiple channel condition predictions for the second wireless device, the multiple channel condition predictions associated with a second time slot that is subsequent to the first time slot, where the multiple channel condition predictions include a first channel condition prediction that is for a first sub-slot of the second time slot and a second channel condition prediction that is for a second sub-slot of the second time slot, and communicate with the second wireless device during the second time slot using multiple precoders, where the multiple precoders include a first precoder for one or more first transmissions during the first sub-slot, the first precoder based on the first channel condition prediction, and a second precoder for one or more second transmissions during the second sub-slot, the second precoder based least in part on the second channel condition prediction.

A method by a first wireless device is described. The method may include transmitting one or more reference signals to a second wireless device, receiving, from the second wireless device, in response to the one or more reference signals, channel estimation information that is associated with observed channel conditions for the second wireless device during a first time slot, determining, based on the received channel estimation information, multiple channel condition predictions for the second wireless device, the multiple channel condition predictions associated with a second time slot that is subsequent to the first time slot, where the multiple channel condition predictions include a first channel condition prediction that is for a first sub-slot of the second time slot and a second channel condition prediction that is for a second sub-slot of the second time slot, and communicating with the second wireless device during the second time slot using multiple precoders, where the multiple precoders include a first precoder for one or more first transmissions during the first sub-slot, the first precoder based on the first channel condition prediction, and a second precoder for one or more second transmissions during the second sub-slot, the second precoder based least in part on the second channel condition prediction.

A first wireless device is described. The first wireless device may include one or more memories storing processor executable code, and one or more processors coupled with the one or more memories. The one or more processors may be individually or collectively operable to execute the code to cause the first wireless device to transmit one or more reference signals to a second wireless device, receive, from the second wireless device, in response to the one or more reference signals, channel estimation information that is associated with observed channel conditions for the second wireless device during a first time slot, determine, based on the received channel estimation information, multiple channel condition predictions for the second wireless device, the multiple channel condition predictions associated with a second time slot that is subsequent to the first time slot, where the multiple channel condition predictions include a first channel condition prediction that is for a first sub-slot of the second time slot and a second channel condition prediction that is for a second sub-slot of the second time slot, and communicate with the second wireless device during the second time slot using multiple precoders, where the multiple precoders include a first precoder for one or more first transmissions during the first sub-slot, the first precoder based on the first channel condition prediction, and a second precoder for one or more second transmissions during the second sub-slot, the second precoder based least in part on the second channel condition prediction.

Another first wireless device is described. The first wireless device may include means for transmitting one or more reference signals to a second wireless device, means for receiving, from the second wireless device, in response to the one or more reference signals, channel estimation information that is associated with observed channel conditions for the second wireless device during a first time slot, means for determining, based on the received channel estimation information, multiple channel condition predictions for the second wireless device, the multiple channel condition predictions associated with a second time slot that is subsequent to the first time slot, where the multiple channel condition predictions include a first channel condition prediction that is for a first sub-slot of the second time slot and a second channel condition prediction that is for a second sub-slot of the second time slot, and means for communicating with the second wireless device during the second time slot using multiple precoders, where the multiple precoders include a first precoder for one or more first transmissions during the first sub-slot, the first precoder based on the first channel condition prediction, and a second precoder for one or more second transmissions during the second sub-slot, the second precoder based least in part on the second channel condition prediction.

A non-transitory computer-readable medium storing code is described. The code may include instructions executable by a processor to transmit one or more reference signals to a second wireless device, receive, from the second wireless device, in response to the one or more reference signals, channel estimation information that is associated with observed channel conditions for the second wireless device during a first time slot, determine, based on the received channel estimation information, multiple channel condition predictions for the second wireless device, the multiple channel condition predictions associated with a second time slot that is subsequent to the first time slot, where the multiple channel condition predictions include a first channel condition prediction that is for a first sub-slot of the second time slot and a second channel condition prediction that is for a second sub-slot of the second time slot, and communicate with the second wireless device during the second time slot using multiple precoders, where the multiple precoders include a first precoder for one or more first transmissions during the first sub-slot, the first precoder based on the first channel condition prediction, and a second precoder for one or more second transmissions during the second sub-slot, the second precoder based least in part on the second channel condition prediction.

Some examples of the method, first wireless devices, and non-transitory computer-readable medium described herein may further include operations, features, means, or instructions for transmitting, to the second wireless device, an indication of a quantity of precoders associated with transmissions from the first wireless device to the second wireless device during the second time slot, where the indicated quantity of precoders may be equal to a quantity of channel condition predictions included in the multiple channel condition predictions.

In some examples of the method, first wireless devices, and non-transitory computer-readable medium described herein, a boundary between the first sub-slot and the second sub-slot may be based on the quantity of precoders, the boundary being between an end symbol of the first sub-slot and a start symbol of the second sub-slot.

Some examples of the method, first wireless devices, and non-transitory computer-readable medium described herein may further include operations, features, means, or instructions for transmitting, to the second wireless device, an indication of the boundary between the first sub-slot and the second sub-slot.

In some examples of the method, first wireless devices, and non-transitory computer-readable medium described herein, operations, features, means, or instructions for transmitting the indication of the quantity of precoders may include operations, features, means, or instructions for transmitting the indication of the quantity of precoders via radio resource control signaling or via downlink control information.

In some examples of the method, first wireless devices, and non-transitory computer-readable medium described herein, using the multiple precoders to communicate with the second wireless device during the second time slot may be based on a velocity of the second wireless device satisfying a threshold velocity.

Some examples of the method, first wireless devices, and non-transitory computer-readable medium described herein may further include operations, features, means, or instructions for receiving, from the second wireless device, capability information indicating support by the second wireless device for communicating in accordance with two or more precoders within a slot, where determining the multiple channel condition predictions may be based on receiving the capability information.

In some examples of the method, first wireless devices, and non-transitory computer-readable medium described herein, the multiple channel condition predictions further include a third channel condition prediction that may be for a third sub-slot of the second time slot.

In some examples of the method, first wireless devices, and non-transitory computer-readable medium described herein, the first channel condition prediction may be based on predicted channel conditions for the second wireless device during a first interior symbol within the first sub-slot of the second time slot, the first interior symbol being between at least two other symbols of the first sub-slot and the second channel condition prediction may be based on predicted channel conditions for the second wireless device during a second interior symbol within the second sub-slot of the second time slot, the second interior symbol being between at least two other symbols of the second sub-slot.

In some examples of the method, first wireless devices, and non-transitory computer-readable medium described herein, the one or more reference signals include at least a first reference signal associated with the first interior symbol within the first sub-slot of the second time slot and the one or more reference signals further include at least a second reference signal associated with the second interior symbol within the second sub-slot of the second time slot.

In some examples of the method, first wireless devices, and non-transitory computer-readable medium described herein, operations, features, means, or instructions for transmitting the one or more reference signals may include operations, features, means, or instructions for transmitting the one or more reference signals to the second wireless device during a third time slot prior to the first time slot.

In some examples of the method, first wireless devices, and non-transitory computer-readable medium described herein, the one or more reference signals are demodulated reference signals (DMRSs).

A method by a second wireless device is described. The method may include receiving one or more reference signals from a first wireless device, transmitting, to the first wireless device, channel estimation information that is based on the one or more reference signals and is associated with observed channel conditions for the second wireless device during a first time slot, receiving, from the first wireless device during a first sub-slot within a second time slot that is subsequent to the first time slot, one or more first transmissions precoded according to a first precoder that is based on the channel estimation information and a first channel condition prediction associated with the first sub-slot, and receiving, from the first wireless device during a second sub-slot within the second time slot, one or more second transmissions precoded according to a second precoder that is based on the channel estimation information and a second channel condition prediction associated with the second sub-slot.

A second wireless device is described. The second wireless device may include one or more memories storing processor executable code, and one or more processors coupled with the one or more memories. The one or more processors may be individually or collectively operable to execute the code to cause the second wireless device to receive one or more reference signals from a first wireless device, transmit, to the first wireless device, channel estimation information that is based on the one or more reference signals and is associated with observed channel conditions for the second wireless device during a first time slot, receive, from the first wireless device during a first sub-slot within a second time slot that is subsequent to the first time slot, one or more first transmissions precoded according to a first precoder that is based on the channel estimation information and a first channel condition prediction associated with the first sub-slot, and receive, from the first wireless device during a second sub-slot within the second time slot, one or more second transmissions precoded according to a second precoder that is based on the channel estimation information and a second channel condition prediction associated with the second sub-slot.

Another second wireless device is described. The second wireless device may include means for receiving one or more reference signals from a first wireless device, means for transmitting, to the first wireless device, channel estimation information that is based on the one or more reference signals and is associated with observed channel conditions for the second wireless device during a first time slot, means for receiving, from the first wireless device during a first sub-slot within a second time slot that is subsequent to the first time slot, one or more first transmissions precoded according to a first precoder that is based on the channel estimation information and a first channel condition prediction associated with the first sub-slot, and means for receiving, from the first wireless device during a second sub-slot within the second time slot, one or more second transmissions precoded according to a second precoder that is based on the channel estimation information and a second channel condition prediction associated with the second sub-slot.

A non-transitory computer-readable medium storing code is described. The code may include instructions executable by a processor to receive one or more reference signals from a first wireless device, transmit, to the first wireless device, channel estimation information that is based on the one or more reference signals and is associated with observed channel conditions for the second wireless device during a first time slot, receive, from the first wireless device during a first sub-slot within a second time slot that is subsequent to the first time slot, one or more first transmissions precoded according to a first precoder that is based on the channel estimation information and a first channel condition prediction associated with the first sub-slot, and receive, from the first wireless device during a second sub-slot within the second time slot, one or more second transmissions precoded according to a second precoder that is based on the channel estimation information and a second channel condition prediction associated with the second sub-slot.

Some examples of the method, second wireless devices, and non-transitory computer-readable medium described herein may further include operations, features, means, or instructions for receiving, from the first wireless device, an indication of a quantity of precoders associated with transmissions from the first wireless device to the first wireless device during the second time slot, where the indicated quantity of precoders may be equal to a quantity of sub-slots within the second time slot.

In some examples of the method, second wireless devices, and non-transitory computer-readable medium described herein, a boundary between the first sub-slot and the second sub-slot may be based on the quantity of precoders, the boundary being between an end symbol of the first sub-slot and a start symbol of the second time slot.

Some examples of the method, second wireless devices, and non-transitory computer-readable medium described herein may further include operations, features, means, or instructions for receiving, from the first wireless device, an indication of the boundary between the first sub-slot and the second sub-slot.

In some examples of the method, second wireless devices, and non-transitory computer-readable medium described herein, operations, features, means, or instructions for receiving the indication of the quantity of precoders may include operations, features, means, or instructions for receiving the indication of the quantity of precoders via radio resource control signaling or via downlink control information.

In some examples of the method, second wireless devices, and non-transitory computer-readable medium described herein, multiple precoders being associated with transmissions during the second time slot may be based on a velocity of the second wireless device satisfying a threshold velocity, the multiple precoders including the first precoder and the second precoder, and the transmissions during the second time slot including the one or more first transmissions and the one or more second transmissions.

Some examples of the method, second wireless devices, and non-transitory computer-readable medium described herein may further include operations, features, means, or instructions for transmitting, to the first wireless device, capability information indicating support by the second wireless device for communicating in accordance with two or more precoders within a slot, where the one or more first transmissions are precoded according to the first precoder and the one or more second transmissions are precoded according to the second precoder based on the capability information.

Some examples of the method, second wireless devices, and non-transitory computer-readable medium described herein may further include operations, features, means, or instructions for receiving, from the first wireless device during a third sub-slot within the second time slot, one or more third transmissions precoded according to a third precoder that may be based on the channel estimation information and a third channel condition prediction associated with the third sub-slot.

In some examples of the method, second wireless devices, and non-transitory computer-readable medium described herein, the first channel condition prediction may be based on predicted channel conditions for the second wireless device during a first interior symbol within the first sub-slot of the second time slot, the first interior symbol being between at least two other symbols of the first sub-slot and the second channel condition prediction may be based on predicted channel conditions for the second wireless device during a second interior symbol within the second sub-slot of the second time slot, the second interior symbol being between at least two other symbols of the second sub-slot.

In some examples of the method, second wireless devices, and non-transitory computer-readable medium described herein, the one or more reference signals include at least a first reference signal associated with the first interior symbol within the first sub-slot of the second time slot and the one or more reference signals further include at least a second reference signal associated with the second interior symbol within the second sub-slot of the second time slot.

In some examples of the method, second wireless devices, and non-transitory computer-readable medium described herein, operations, features, means, or instructions for receiving the one or more reference signals may include operations, features, means, or instructions for receiving the one or more reference signals from the first wireless device during a third time slot prior to the first time slot.

In some examples of the method, second wireless devices, and non-transitory computer-readable medium described herein, the one or more reference signals are DMRSs.

### BRIEF DESCRIPTION OF THE DRAWINGS

FIGS. 1 and 2 show examples of wireless communication systems that support sub-slot precoding for wireless communications in accordance with one or more aspects of the present disclosure.

FIG. 3 shows an example of a timing diagram that supports sub-slot precoding for wireless communications in accordance with one or more aspects of the present disclosure.

FIG. 4 shows an example of a process flow that supports sub-slot precoding for wireless communications in accordance with one or more aspects of the present disclosure.

FIGS. 5 and 6 show block diagrams of devices that support sub-slot precoding for wireless communications in accordance with one or more aspects of the present disclosure.

FIG. 7 shows a block diagram of a communications manager that supports sub-slot precoding for wireless communications in accordance with one or more aspects of the present disclosure.

FIG. 8 shows a diagram of a system including a device that supports sub-slot precoding for wireless communications in accordance with one or more aspects of the present disclosure.

FIGS. 9 and 10 show block diagrams of devices that support sub-slot precoding for wireless communications in accordance with one or more aspects of the present disclosure.

FIG. 11 shows a block diagram of a communications manager that supports sub-slot precoding for wireless communications in accordance with one or more aspects of the present disclosure.

FIG. 12 shows a diagram of a system including a device that supports sub-slot precoding for wireless communications in accordance with one or more aspects of the present disclosure.

FIGS. 13 and 14 show flowcharts illustrating methods that support sub-slot precoding for wireless communications in accordance with one or more aspects of the present disclosure.

### DETAILED DESCRIPTION

In some examples of wireless communications, one or more devices may operate in accordance with multi-user multi-input/multi-output (MU-MIMO) communications. For example, a network entity may concurrently transmit (e.g., via at least partially overlapping time-frequency resources) multiple data streams to a set of spatially multiplexed user equipments (UEs). In some examples, MU-MIMO communications may be based on updating a precoding matrix at the network entity using information of a channel from each network entity transmission antenna (or antenna port) to each UE reception antenna (or antenna port). The network entity may periodically transmit channel state information reference signals (CSI-RSs) and receive the information of the channel based on feedback from each UE in response to the CSI-RSs. In some examples, the network entity may receive the information of the channel by receiving sounding reference signals (SRSs) from each UE. In some cases, however, the periodicity of transmitting CSI-RS and SRS may occur every several slots. As such, if the set of UEs are operating in a high mobility environment, the precoding matrix may become outdated in between reference signal transmissions, which may degrade spatial separation and orthogonality of data channels between the set of UEs.

As described herein, the network entity and the set of UEs may increase precoding reliability by applying multiple precoders per slot. For example, in slots not including a CSI-RS or SRS transmission, the network entity may transmit one or more demodulated reference signals (DMRSs) for each UE (e.g., a first DMRS using a first set of precoding parameters and an extended DMRS using a second set of precoding parameters orthogonal to the first set of precoding parameters). The network entity may receive, per-slot, channel estimation feedback from each UE and utilize this feedback to predict multiple updated channels and calculate multiple updated precoders for one or more future slots. By applying multiple precoders per slot, the network entity may update the associated precoding matrix faster which may increase precoding reliability for higher mobility MU-MIMO communications while retaining UE orthogonality.

Aspects of the disclosure are initially described in the context of wireless communications systems. Aspects of the disclosure are further described in the context of timing diagrams and process flows. Aspects of the disclosure are further illustrated by and described with reference to apparatus diagrams, system diagrams, and flowcharts that relate to sub-slot precoding for wireless communications.

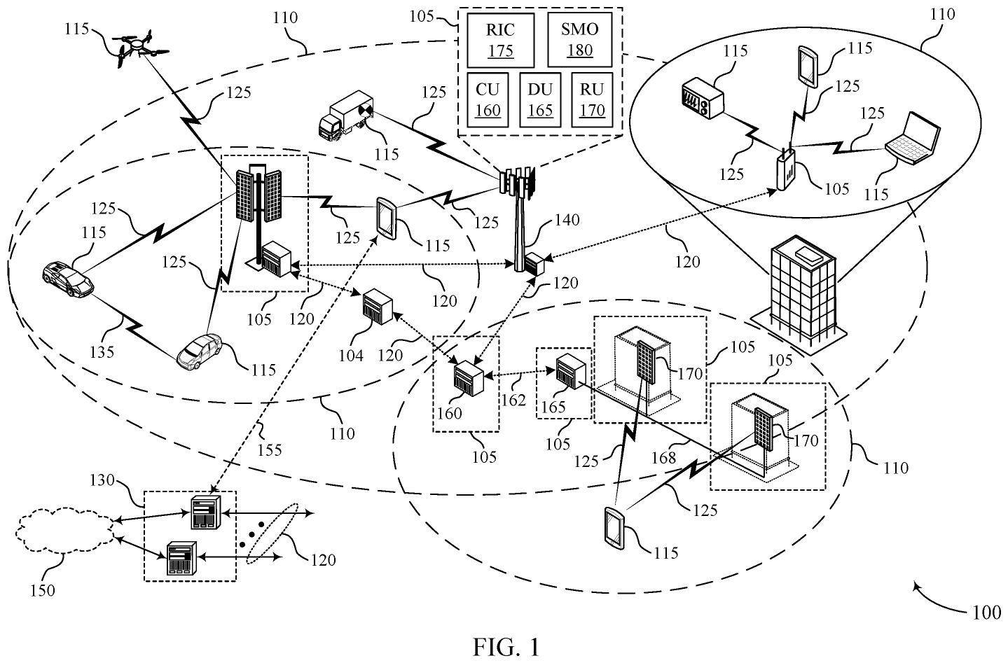

FIG. 1 shows an example of a wireless communications system 100 that supports sub-slot precoding for wireless communications in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c. F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support sub-slot precoding for wireless communications as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Ts=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

As described herein, the network entity 105 and the UEs 115 may increase precoding reliability by applying multiple precoders per slot. For example, in slots not including a CSI-RS or SRS transmission, the network entity 105 may transmit one or more demodulated reference signals (DMRSs) for each of the UEs 115 (e.g., a first DMRS using a first set of precoding parameters and an extended DMRS using a second set of precoding parameters orthogonal to the first set of precoding parameters). The network entity 105 may receive, per-slot, channel estimation feedback from each of the UEs 115 and utilize this feedback to predict multiple updated channels and calculate multiple updated precoders for each slot. By applying multiple precoders per slot, the network entity 105 may update the associated precoding matrix faster which may increase precoding reliability for higher mobility MU-MIMO communications while retaining UE orthogonality.

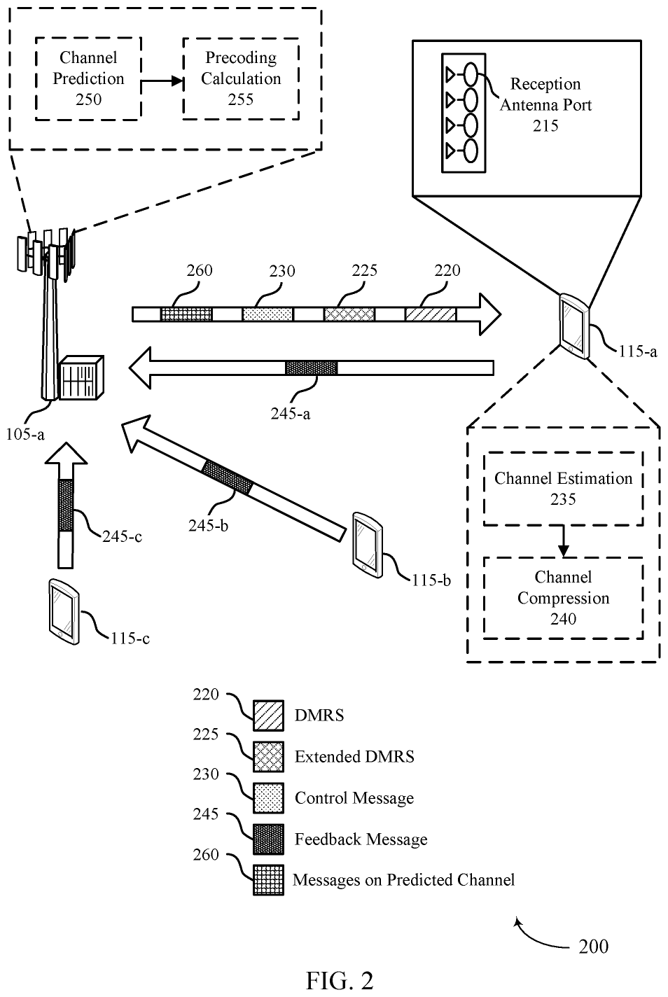

FIG. 2 shows an example of a wireless communications system 200 that supports sub-slot precoding for wireless communications in accordance with one or more aspects of the present disclosure. In some examples, the wireless communications system 200 may implement aspects of a wireless communications system 100. For example, the wireless communications system 200 may include a network entity 105-a and UEs 115-a, 115-b, and 115-c, which may be examples of a network entity 105 and UEs 115, as described with reference to FIG. 1.

In some examples of wireless communications system 100, one or more devices may operate in accordance with MU-MIMO communications. For example, the network entity 105-a may concurrently transmit multiple data streams to the UEs 115, where the UEs 115 may be spatially multiplexed. In some examples, MU-MIMO communications may be based on updating a precoding matrix at the network entity 105-a using information of a channel from each network entity 105-a transmission antenna port 205 (e.g., transmission antenna port 205-a and 205-b) to each UE 115 reception antenna port 215. The network entity 105-a may receive the information for the channel based on periodically communicating CSI-RSs, SRSs, or both and receive feedback from each UE 115. In some examples of channel reciprocity, the network entity 105-a may receive an SRS from various UE 115 antennas for each UE 115 and measure the associated uplink channels.

In some cases, however, the periodicity of transmitting CSI-RS and SRS may occur every several slots. As such, if the set of UEs 115 are operating in a high mobility environment, the precoding matrix at the network entity 105-a may become insufficient or outdated in between reference signal transmissions, which may degrade spatial separation and orthogonality of data channels between the set of UEs 115. Additionally, or alternatively, SRS transmission may have a lack reciprocity in some communication modes (e.g., FDD mode) and may have a limited link budget (e.g., associated with a lower signal to noise ratio (SNR)). In some cases, a limited link budget may increase a time associated with switching between uplink transmissions and downlink transmission, which may increase latency of the system.

According to the techniques described herein, the network entity 105-a and the UEs 115 may increase precoding reliability by applying multiple precoders per slot. For example, in slots that are not associated with (e.g., do not include, are not scheduled for) a CSI-RS or SRS transmission, the network entity 105-a may transmit one or more DMRSs 220 for each UE 115. For example, each UE 115 may receive a DMRS 220, which may be used by each respective UE 115 to decode downlink data transmissions (e.g., physical downlink shared channel (PDSCH) transmissions) from the network entity 105-a and as such, may be received by the UEs 115 in downlink slots that contain or are scheduled for data. In some examples, the network entity 105-a may precode the DMRS 220 before transmitting the DMRS 220 to the UE 115-a. Precoding may refer to the process of mapping layered data to antenna ports for transmission via a device such as network entity 105-a or UE 115-a. In some cases, precoding may involve multiplying a multi-bit signal with a precoding matrix such that each reception antenna port 215 at a UE 115-a may obtain, upon reception, one or more data layers with a given weighting. If the quantity of transmit antenna ports 205 at the network entity 105-a is larger than a quantity of layers used to transmit the DMRS 220, the DMRS 220 may be precoded using non-square precoding (e.g., a quantity of rows of the precoding matrix is not equal to a quantity of columns of the precoding matrix).

The network entity 105-a may additionally transmit an extended DMRS 225. The extended DMRS 225 may be referred to as a pilot signal. The precoding matrix used to precode the extended DMRS 225 may be different from the precoding matrix used to precode the DMRS 220, but in some examples, may be associated with a precoding matrix used to precode the DMRS 220. For example, the precoding matrix used to precode the extended DMRS 225 may be orthogonal to the precoding used to precode the DMRS 220. In some examples, the network entity 105-a may transmit a control message 230 that may indicate a set of information for processing the DMRS 220 for decoding and processing the extended DMRS 225.

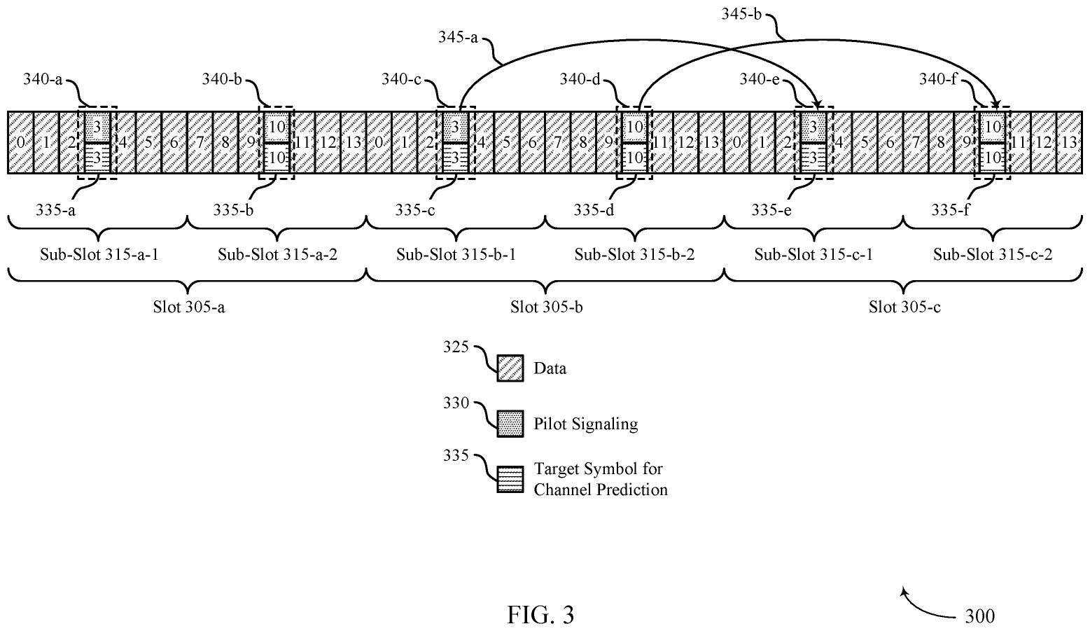

If a UE 115-a supports the use of the extended DMRS 225, the UE 115 may receive the extended DMRS 225 and the DMRS 220 from the network entity 105-a and estimate one or more downlink channels (e.g., a downlink channel matrix) based on the DMRS 220 and the extended DMRS 225. For example, the UE 115-a may perform one or more channel estimations 235 of the downlink channel associated using the DMRS 220 and the extended DMRS 225. In some examples, the UEs 115 may perform the channel estimations using tracking of a power delay profile of the precoded channels over multiple time slots. That is, the UEs 115 may use channel estimations of the precoded channels from previous time slots to generate the channel estimations. Based on performing the channel estimations, the UEs 115 may perform channel compressions. Further discussion of channel estimations is described herein, including with reference to FIG. 3.

Based on performing the channel estimations 235, each UE may transmit a respective feedback message 245. For example, UE 115-a may transmit feedback message 245-a, UE 115-b may transmit feedback message 245-b, and UE 115-c may transmit feedback message 245-c. As such, the network entity 105-a may receive the respective feedback messages 245 from each of the UEs 115 and perform one or more channel predictions 250. In some examples, one or more of the UEs 115 may transmit (e.g., to the network entity 105-a) capability information supported by each of the UEs 115 prior to the network entity 105-a transmitting the one or more reference signals. The capability information may indicate to the network entity 105-a that the UEs 115 may support more than one (e.g., multiple) precoders within a slot.

The network entity 105-a may predict one or more channel response vectors per UE 115, for a desired. The network entity 105-a may predict the channel response vectors using the multiple channel feedback messages sent from the UEs 115. The network entity 105-a may generate multiple MU-MIMO channel predictions based on the respective feedback messages 245. In some examples, the network entity 105-a may generate the MU-MIMO channel predictions using additional messages from the respective UEs 115 (e.g., feedback messages 245 including channel estimation 235 for previous slots).

After generating the channel predictions 250, the network entity 105-a may perform one or more precoding calculations 255 (e.g., generate one or more sets of precoding parameters associated with the predicted channels). For example, the network entity 105-a may use the generated MU-MIMO channel predictions to generate one or more MU-MIMO channel precoders per slot associated with the set of UEs 115. The network entity may precode messages according to the determined precoders and transmit the precoded messages 260 on the one or more predicted channels. Further discission of the channel predictions 250 and the precoding calculations 255 are described herein, including with reference to FIG. 3.

As such, the network entity and the UEs 115 may increase precoding reliability by applying multiple precoders per slot. For example, in slots not including a CSI-RS or SRS transmission, the network entity 105-a may transmit one or more DMRSs for each of the UEs 115. The network entity 105-a may receive, per-slot, channel estimation feedback from each of the UEs 115 and utilize this feedback to predict multiple updated channels and multiple updated precoders for each slot. By applying multiple precoders per slot, the network entity 105-a may update the associated precoding matrix often (e.g., faster) which may increase precoding reliability for higher mobility MU-MIMO communications while retaining orthogonality of the UEs 115.

In some examples, the network entity 105-a may account for a velocity of the UEs 115 when generating the channel precoders. For example, the network entity 105-a may estimate a velocity of each of the UEs 115 and may utilize the estimated velocities to determine a quantity of precoders to calculate and apply (e.g., a quantity of sub-slots to divide each slot into). In the case that one or more of the UEs 115 is associated with a low velocity (e.g., a low mobility scenario), the channel may not vary rapidly and thus the network entity 105-a may not apply multiple precoders to the slot (e.g., may apply a single precoder to the slot or to a group of slots that includes the slot). In the case that one or more of the UEs 115 is associated with a high velocity (e.g., a high mobility scenario), the channel may vary rapidly and thus would benefit from the network entity 105-a applying multiple precoders to the slot. Thus, in accordance with the teachings herein, the granularity with which precoders are changed (e.g., how many precoders are used per unit time, such as per slot) may depend on UE velocity, such as by using multiple precoders pers lot when UE velocity meets or exceeds a threshold velocity.

FIG. 3 shows an example of a timing diagram 300 that supports sub-slot precoding for wireless communications in accordance with one or more aspects of the present disclosure. In some examples, the timing diagram 300 may include or be implemented by aspects of the wireless communications systems 100 and 200, described with reference to FIGS. 1 and 2. For example, the timing diagram 300 may be implemented by a network entity and a UE, which may be examples of the network entities 105 and the UEs 115 as described with reference to FIGS. 1 and 2.

The timing diagram 300 may include slots 305 that may include sub-slots 315. For example, the timing diagram 300 may include the slot 305-a, the slot 305-b, and the slot 305-c. Each slot may include one or more data symbols 325, one or more pilot signals 330, and one or more target symbols 335 (e.g., target symbol 335-a, target symbol 335-b, target symbol 335-c, target symbol 335-d, target symbol 335-e, target symbol 335-f) for channel predictions. The slot 305-a may include the sub-slot 315-a-1 and the sub-slot 315-a-2, and each of the sub-slots 315-a may include a middle symbol 340 (e.g., a middle symbol 340-a, a middle symbol 340-b). Similarly, the slot 305-b may include the sub-slot 315-b-1 and the sub-slot 315-b-2, and each of the sub-slots 315-b may include one of the middle symbols 340 (e.g., a middle symbol 340-c, a middle symbol 340-d). The slot 305-c may include the sub-slot 315-c-1 and the sub-slot 315-c-2, and each of the sub-slots 315-c may include one of the middle symbols 340 (e.g., a middle symbol 340-e, a middle symbol 340-f).

The network entity may transmit (e.g., during a high-mobility scenario) one or more reference signals to the UE to be used in channel estimation procedures at the UE. The network entity may transmit one or more pilot signals 330 (e.g., a reference signal, a DMRS) to the UE in the middle symbol 340-a and the middle symbol 340-b (e.g., the symbol 3, the symbol 10) during the slot 305-a. The UE may receive the pilot signals and utilize them to perform channel estimation operations. The UE may transmit information associated with the channel estimations to the network entity. For example, the UE may transmit the channel estimation information to the network entity in the middle symbol 340-c and the middle symbol 340-d (e.g., the symbol 3, the symbol 10) of the slot 305-b. In some examples, the UE may utilize use data-aided techniques in performing channel estimation operations such that the estimation quality of symbols farther from the DMRSs may improve.

The network entity may use the received channel estimation information to predict channel conditions for the slot 305-c. For example, the network entity may receive the transmitted channel estimation information in the middle symbol 340-c and the middle symbol 340-d (e.g., the symbol 3, the symbol 10) of the slot 305-b. The network entity may utilize the received channel estimation information to perform multiple channel predictions 345 for the slot 305-c. For example, the network entity may break the slot 305-c into the sub-slot 315-c-1 and the sub-slot 315-c-2, and may perform a channel prediction for each of the sub-slots 315-c. That is, the network entity may utilize the channel estimation information received in the middle symbol 340-c (e.g., symbol 3) of the slot 305-b to perform a channel prediction operation 345-a for the target symbol 335-e (e.g., middle symbol 340-c, symbol 3) of the sub-slot 315-c-1. The network entity may also utilize the channel estimation information received in the middle symbol 340-d (e.g., symbol 10) of the slot 305-b to perform a channel prediction operation 345-b for the target symbol 335-f (e.g., middle symbol 340-f, symbol 10) of the sub-slot 315-c-2.

Upon completing the multiple channel predictions, the network entity may calculate and apply precoders to each of the sub-slots 315 of the slot 305-c. The network entity may utilize the channel prediction information to calculate a precoder for each of the sub-slots 315 of the slot 305-c. For example, the network entity may utilize the channel prediction information to calculate a precoder based on the middle symbol 340-e of the sub-slot 315-c-1 and a precoder based on the middle symbol 340-f of the sub-slot 315-c-2. In some examples, the precoders may be different, while in some other examples, the precoders may be the same. The network entity may apply the precoders to each of the sub-slots 315 such that the slot 305-c may include two different precoders. For example, the network entity may apply a first precoder of the calculated precoders to the various symbols of the sub-slot 315-c-1 and the network entity may apply a second precoder of the calculated precoders to the various symbols of the sub-slot 315-c-2. The quantity of precoders the network entity calculates and applies may be based on (e.g., equal to) a quantity of the sub-slots 315-c included in the slot 305-c. Thus, in some examples, the network entity may calculate and apply more than two precoders to the slot 305-c (e.g., in the case that the slot 305-c may include more than two sub-slots 315-c).

In some examples, the network entity may account for a velocity of the UE when breaking the slot 305-c into the sub-slots 315-c and applying precoders. For example, the network entity may estimate a velocity of the UE (e.g., or receive an indication of the UE velocity from the UE) and may utilize the estimated velocity to determine a quantity of precoders to calculate and apply (e.g., a quantity of sub-slots 315-c to divide the slot 305-c into). In the case that the UE is associated with a low velocity (e.g., low mobility scenarios), the channel may not vary rapidly and thus the network entity may not apply multiple precoders to the slot 305-c. In the case that the UE is associated with a high velocity (e.g., high mobility scenarios), the channel may vary rapidly and thus would benefit from the network entity applying multiple precoders to the slot 305-c.

The network entity may transmit messages to the UE during the precoded sub-slots 315-c. For example, based on calculating and applying the precoders to the slot 305-c, the network entity may communicate one or more messages precoded according to the first precoder with the UE during the sub-slot 315-c-1 and may communicated one or more messages precoded according to the second precoder with the UE during the sub-slot 315-c-2. Thus, the network entity may communicate (e.g., with the UE) messages associated with multiple precoders during the slot 305-c.

The network entity may indicate to the UE that more than one precoders are associated with the slot 305-c. For example, the network entity may transmit (e.g., to the UE) an indication (e.g., a value) of the quantity of precoders calculated and applied to the slot 305-c. In some cases, the indicated the quantity of precoders may be the same as a quantity of the channel predictions performed at the network entity. In some cases, the indication may be associated with the symbols of the slot 305-c (e.g., the symbols of the sub-slots 315-c). In some examples, the network entity may transmit this indication as part of an RRC or DCI message.

The UE may receive the messages and the indication of the quantity of precoders, and may decode the precoded messages received from the network entity. For example, the UE may receive the one or more messages precoded according to the first precoder in the sub-slot 315-c-1 and the one or more messages precoded according to the second precoder in the sub-slot 315-c-2. The UE may receive the precoded messages during the sub-slots 315-c (e.g., the slot 305-c) according to the following equations:

$$\begin{matrix}{Y}^{i} [ l ] = {H}^{i} [ l ] \cdot {P}_{1}^{i} \cdot s + {n}_{i} & Symbol l ∈ [ 0 : 6 ] \\ {Y}^{i} [ l ] = {H}^{i} [ l ] \cdot {P}_{2}^{i} \cdot s + {n}_{i} & Symbol l ∈ [ 7 : 14 ]\end{matrix}$$

Where Yⁱ[l] represents the channel for a symbol 1 and a UEᵢ, Hⁱ[l] represents the channel for the symbol 1 and the UEᵢ, nᵢ represents noise associated with the UEᵢ, and the P and j of Pⱼⁱ represent the precoding applied and the sub-slot, respectively. The UE may also receive the indication of the quantity of precoders. The UE may utilize the indication of the quantity of precoders to determine the precoders associated with the sub-slots 315-c, and may decode the messages transmitted by the network entity during the sub-slots 315-c of the slot 305-c.

By utilizing multiple precoders per slot, the network entity may update the associated precoding matrix faster which may increase precoding reliability for higher mobility MU-MIMO communications while retaining orthogonality of the UE (e.g., the one or more UEs). Additionally, for high-mobility scenarios, utilizing multiple precoders during a slot may result in the precoders of the slot being more closely associated with the channel.

Although some examples described herein involve two sub-slots 315 per slot 305, and correspondingly the use of two precoders for communications within a single slot 305, it is to be understood that the teachings herein may be applied to use any quantity of precoders and any quantity of sub-slots 315 per slot 305.

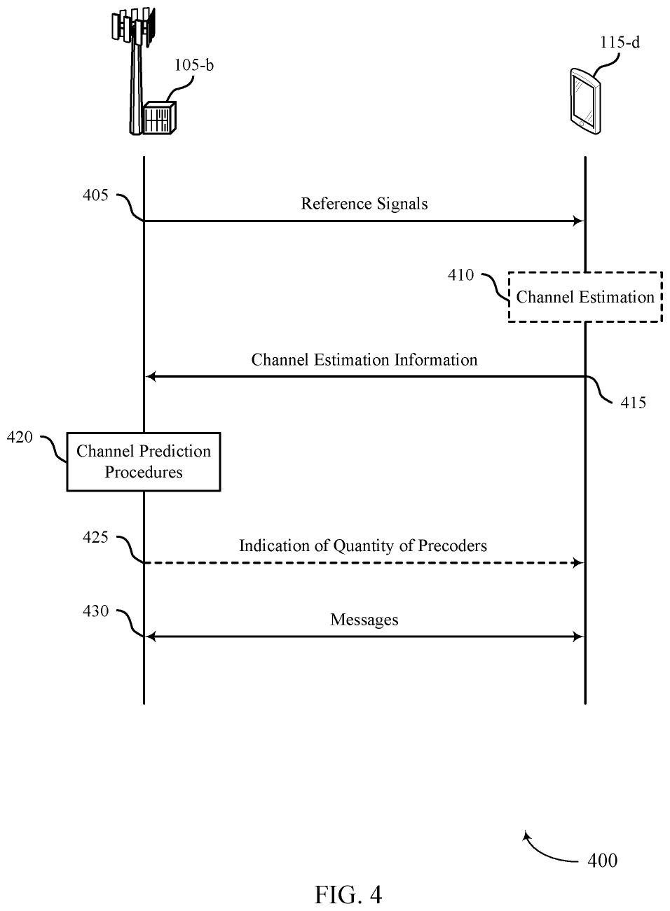

FIG. 4 shows an example of a process flow 400 that supports sub-slot precoding for wireless communications in accordance with one or more aspects of the present disclosure. In some examples, process flow 400 may implement or be implemented by aspects of wireless communications system 100, wireless communications system 200, and timing diagram 300. Process flow 400 includes a UE 115-d and a network entity 105-b which may be respective examples of a UE 115 and a network entity 105, as described with reference to FIGS. 1 and 2. Alternative examples of the following may be implemented, where some steps are performed in a different order than described or are not performed at all. In some cases, steps may include additional features not mentioned below, or further steps may be added. In addition, while process flow 400 shows processes between a single UE 115 and a single network entity 105, it should be understood that these processes may occur between any quantity of network devices and network device types. For example, the process flow 400 may be adapted in which the network entity 105-b communicates with a set of UEs 115 via MU-MIMO communication techniques described herein.

At 405, the network entity 105-b may transmit (e.g., to the UE) one or more reference signals during a first time slot. In some examples, the one or more reference signals may be examples of DMRSs. The one or more reference signals may include a first reference signal associated with (e.g., associated with channel estimation in order to support a channel prediction 345 for) a middle symbol of a first sub-slot (e.g., of a third time slot subsequent to the first time slot), and a second reference signal associated with (e.g., associated with channel estimation in order to support a channel prediction 345 for) a middle symbol of a second sub-slot (e.g., of the third time slot). In some examples, the UE 115-d may transmit (e.g., to the network entity 105-b) capability information supported by the UE 115-d prior to the network entity 105-b transmitting the one or more reference signals. The capability information may indicate to the network entity 105-b that the UE 115-d may support more than one (e.g., multiple) precoders within a slot.

In some examples, at 410, the UE 115-d may perform one or more channel estimations. For example, in response to receiving the reference signals, the UE 115-d may perform one or more channel estimations based on the reference signals and observed channel conditions associated with the UE 115-d.

At 415, the UE 115-d may transmit (e.g., to the network entity 105-b) information associated with the channel estimations during a second time slot subsequent to the first time slot and prior to the third time slot.

At 420, the network entity 105-b may perform one or more (e.g., multiple) channel prediction procedures. For example, in response to receiving the channel estimation information from the UE 115-d, the network entity 105-b may perform a first channel prediction for the first sub-slot of the third time slot and a second channel prediction for the second sub-slot of the third time slot. The channel prediction procedures may be based on the received capability information and the received channel estimation information. In some examples, the first channel condition prediction may be based on predicted channel conditions for the UE 115-d during the first middle symbol (e.g., first interior symbol) within the first sub-slot of the third time slot. The first middle symbol may be located between at least two other symbols of the first sub-slot of the third time slot. Additionally, the second channel condition prediction may be based on predicted channel conditions for the UE 115-d during a second middle symbol (e.g., a second interior symbol) within the second sub-slot of the third time slot. The second interior symbol may be located between at least two other symbols of the second sub-slot of the third time slot. In some cases, the channel prediction procedures may also include a third channel prediction for a third sub-slot of the third time slot.

In some examples, the network entity 105-b may determine whether a velocity of the UE 115-d satisfies a threshold velocity. For example, the UE 115-d may indicate a velocity of the UE 115-d to the network entity 105-b, and the network entity 105-b may determine whether the velocity satisfies the threshold velocity.

In some examples, at 425, the network entity 105-b may indicate (e.g., to the UE 115-d) a quantity of precoders. For example, the network entity 105-b may transmit, and the UE 115-d may receive, an indication of the quantity of precoders associated with transmissions from the network entity 105-b to the UE 115-d. The quantity of precoders may be equal to the total quantity of channel condition prediction procedures performed by the network entity 105-b. For example, the network entity 105-b may indicate the quantity of precoders as a value representing the first channel prediction for the first sub-slot of the third time slot and the second channel prediction for the second sub-slot of the third time slot (e.g., a value of 2). In some examples, the network entity 105-b may transmit the indication of the quantity of precoders via RRC signaling, via DCI, or a combination thereof. As such, the UE 115-d may receive the indication of the quantity of precoders via the RRC signaling, via the DCI, or a combination thereof.

One or more boundaries may be located between the first sub-slot of the third time slot and the second sub-slot of the third time slot, and may be based on the quantity of precoders. For example, a boundary may be located between an end symbol of the first sub-slot and a start symbol of the second sub-slot. In some examples, the network entity 105-b may transmit, and the UE 115-d may receive, an indication of the boundary located between the first sub-slot and the second sub-slot. And in some examples, the boundary between sub-slots may be implicit (e.g., implicitly understood by the UE 115-d) based on the indication of the quantity of precoders (e.g., the slot may be divided evenly or otherwise according to one or more preconfigured rules based on the quantity of precoders).

At 430, the network entity 105-b may communicate (e.g., with the UE 115-d) using one or more (e.g., multiple) precoders during the third time slot. For example, in response to determining that the velocity of the UE 115-d satisfies the threshold velocity, the network entity 105-b may transmit one or more messages precoded according to a first precoder during the first sub-slot of the third time slot and one or more messages precoded according to a second precoder during the second sub-slot of the third time slot. In response to transmitting the capability information, the UE 115-d may receive (e.g., from the network entity 105-b), during the first sub-slot of the third time slot, one or more first transmissions precoded according to the first precoder. The UE 115-d may also receive (e.g., from the network entity 105-b), during the second sub-slot of the third time slot, one or more second transmissions precoded according to the second precoder. The first precoder may be based on the channel estimation information and the first channel condition prediction procedure performed by the network entity 105-b, and the second precoder may be based on the channel estimation information and the second channel condition prediction procedure.

In some examples, the network entity 105-b may also communicate (e.g., with the UE 115-d) one or more messages precoded according to a third precoder during the third sub-slot of the third time slot. Thus, the UE 115-d may receive (e.g., from the network entity 105-b), during the third sub-slot of the third time slot, one or more third transmissions precoded according to the third precoder. The third precoder may be based on the channel estimation information and the third channel condition prediction procedure performed by the network entity 105-b.

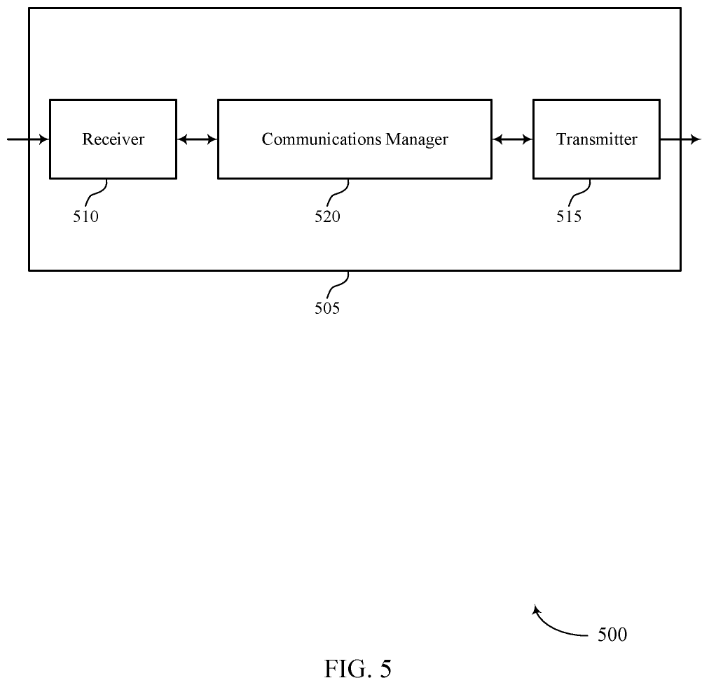

FIG. 5 shows a block diagram 500 of a device 505 that supports sub-slot precoding for wireless communications in accordance with one or more aspects of the present disclosure. The device 505 may be an example of aspects of a network entity 105 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to, individually or collectively, support or enable the described techniques. Each of these components may be in communication with one another (e.g., via one or more buses).

The receiver 510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 505. In some examples, the receiver 510 may support obtaining information by receiving signals via one or more antennas. Additionally, or alternatively, the receiver 510 may support obtaining information by receiving signals via one or more wired (e.g., electrical, fiber optic) interfaces, wireless interfaces, or any combination thereof.

The transmitter 515 may provide a means for outputting (e.g., transmitting, providing, conveying, sending) information generated by other components of the device 505. For example, the transmitter 515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 515 may support outputting information by transmitting signals via one or more antennas. Additionally, or alternatively, the transmitter 515 may support outputting information by transmitting signals via one or more wired (e.g., electrical, fiber optic) interfaces, wireless interfaces, or any combination thereof. In some examples, the transmitter 515 and the receiver 510 may be co-located in a transceiver, which may include or be coupled with a modem.

The communications manager 520, the receiver 510, the transmitter 515, or various combinations thereof or various components thereof may be examples of means for performing various aspects of sub-slot precoding for wireless communications as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor. If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

For example, the communications manager 520 is capable of, configured to, or operable to support a means for transmitting one or more reference signals to a second wireless device. The communications manager 520 is capable of, configured to, or operable to support a means for receiving, from the second wireless device, in response to the one or more reference signals, channel estimation information that is associated with observed channel conditions for the second wireless device during a first time slot. The communications manager 520 is capable of, configured to, or operable to support a means for determining, based on the received channel estimation information, multiple channel condition predictions for the second wireless device, the multiple channel condition predictions associated with a second time slot that is subsequent to the first time slot, where the multiple channel condition predictions include a first channel condition prediction that is for a first sub-slot of the second time slot and a second channel condition prediction that is for a second sub-slot of the second time slot. The communications manager 520 is capable of, configured to, or operable to support a means for communicating with the second wireless device during the second time slot using multiple precoders, where the multiple precoders include a first precoder for one or more first transmissions during the first sub-slot, the first precoder based on the first channel condition prediction, and a second precoder for one or more second transmissions during the second sub-slot, the second precoder based least in part on the second channel condition prediction.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced processing and more efficient utilization of communication resources.

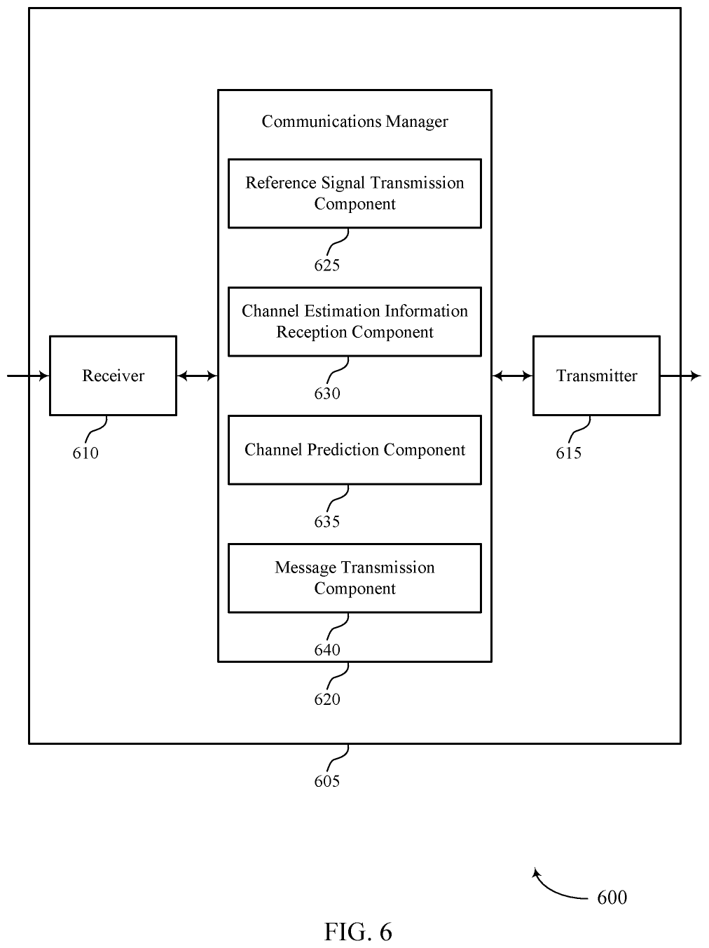

FIG. 6 shows a block diagram 600 of a device 605 that supports sub-slot precoding for wireless communications in accordance with one or more aspects of the present disclosure. The device 605 may be an example of aspects of a device 505 or a network entity 105 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to support the described techniques. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The device 605, or various components thereof, may be an example of means for performing various aspects of sub-slot precoding for wireless communications as described herein. For example, the communications manager 620 may include a reference signal transmission component 625, a channel estimation information reception component 630, a channel prediction component 635, a message transmission component 640, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The reference signal transmission component 625 is capable of, configured to, or operable to support a means for transmitting one or more reference signals to a second wireless device. The channel estimation information reception component 630 is capable of, configured to, or operable to support a means for receiving, from the second wireless device, in response to the one or more reference signals, channel estimation information that is associated with observed channel conditions for the second wireless device during a first time slot. The channel prediction component 635 is capable of, configured to, or operable to support a means for determining, based on the received channel estimation information, multiple channel condition predictions for the second wireless device, the multiple channel condition predictions associated with a second time slot that is subsequent to the first time slot, where the multiple channel condition predictions include a first channel condition prediction that is for a first sub-slot of the second time slot and a second channel condition prediction that is for a second sub-slot of the second time slot. The message transmission component 640 is capable of, configured to, or operable to support a means for communicating with the second wireless device during the second time slot using multiple precoders, where the multiple precoders include a first precoder for one or more first transmissions during the first sub-slot, the first precoder based on the first channel condition prediction, and a second precoder for one or more second transmissions during the second sub-slot, the second precoder based least in part on the second channel condition prediction.

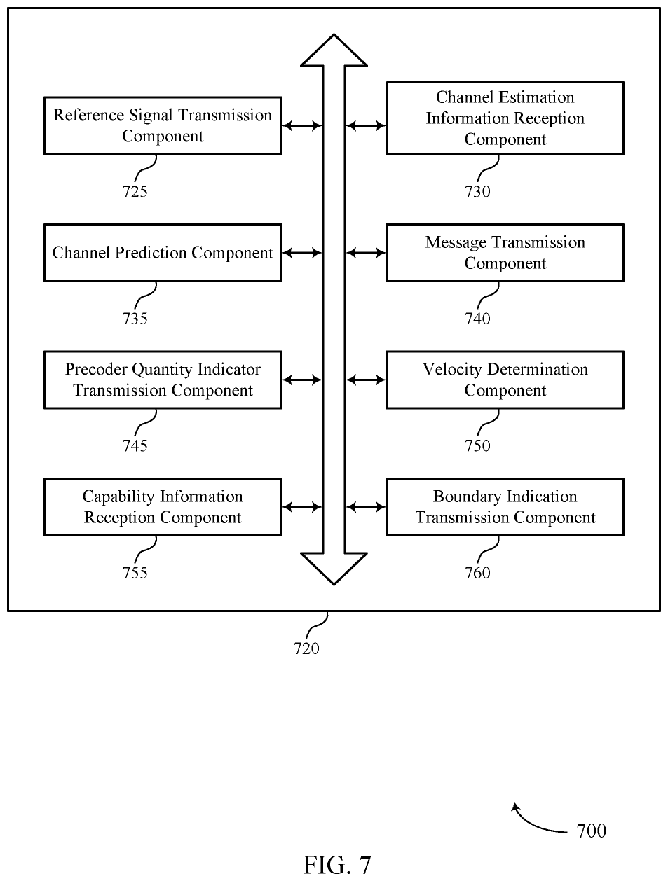

FIG. 7 shows a block diagram 700 of a communications manager 720 that supports sub-slot precoding for wireless communications in accordance with one or more aspects of the present disclosure. The communications manager 720 may be an example of aspects of a communications manager 520, a communications manager 620, or both, as described herein. The communications manager 720, or various components thereof, may be an example of means for performing various aspects of sub-slot precoding for wireless communications as described herein. For example, the communications manager 720 may include a reference signal transmission component 725, a channel estimation information reception component 730, a channel prediction component 735, a message transmission component 740, a precoder quantity indicator transmission component 745, a velocity determination component 750, a capability information reception component 755, a boundary indication transmission component 760, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The reference signal transmission component 725 is capable of, configured to, or operable to support a means for transmitting one or more reference signals to a second wireless device. The channel estimation information reception component 730 is capable of, configured to, or operable to support a means for receiving, from the second wireless device, in response to the one or more reference signals, channel estimation information that is associated with observed channel conditions for the second wireless device during a first time slot. The channel prediction component 735 is capable of, configured to, or operable to support a means for determining, based on the received channel estimation information, multiple channel condition predictions for the second wireless device, the multiple channel condition predictions associated with a second time slot that is subsequent to the first time slot, where the multiple channel condition predictions include a first channel condition prediction that is for a first sub-slot of the second time slot and a second channel condition prediction that is for a second sub-slot of the second time slot. The message transmission component 740 is capable of, configured to, or operable to support a means for communicating with the second wireless device during the second time slot using multiple precoders, where the multiple precoders include a first precoder for one or more first transmissions during the first sub-slot, the first precoder based on the first channel condition prediction, and a second precoder for one or more second transmissions during the second sub-slot, the second precoder based least in part on the second channel condition prediction.

In some examples, the precoder quantity indicator transmission component 745 is capable of, configured to, or operable to support a means for transmitting, to the second wireless device, an indication of a quantity of precoders associated with transmissions from the first wireless device to the second wireless device during the second time slot, where the indicated quantity of precoders is equal to a quantity of channel condition predictions included in the multiple channel condition predictions.

In some examples, a boundary between the first sub-slot and the second sub-slot is based on the quantity of precoders, the boundary being between an end symbol of the first sub-slot and a start symbol of the second sub-slot.

In some examples, the boundary indication transmission component 760 is capable of, configured to, or operable to support a means for transmitting, to the second wireless device, an indication of the boundary between the first sub-slot and the second sub-slot.

In some examples, to support transmitting the indication of the quantity of precoders, the precoder quantity indicator transmission component 745 is capable of, configured to, or operable to support a means for transmitting the indication of the quantity of precoders via radio resource control signaling or via downlink control information.

In some examples, the velocity determination component 750 is capable of, configured to, or operable to support a means for determining whether a velocity of the second wireless device satisfies a threshold velocity. In some examples, using the multiple precoders to communicate with the second wireless device during the second time slot is based on the velocity of the second wireless device satisfying the threshold velocity.

In some examples, the capability information reception component 755 is capable of, configured to, or operable to support a means for receiving, from the second wireless device, capability information indicating support by the second wireless device for communicating in accordance with two or more precoders within a slot, where determining the multiple channel condition predictions is based on receiving the capability information.

In some examples, the multiple channel condition predictions further include a third channel condition prediction that is for a third sub-slot of the second time slot.

In some examples, the first channel condition prediction is based on predicted channel conditions for the second wireless device during a first interior symbol within the first sub-slot of the second time slot, the first interior symbol being between at least two other symbols of the first sub-slot. In some examples, the second channel condition prediction is based on predicted channel conditions for the second wireless device during a second interior symbol within the second sub-slot of the second time slot, the second interior symbol being between at least two other symbols of the second sub-slot.

In some examples, the one or more reference signals include at least a first reference signal associated with the first interior symbol within the first sub-slot of the second time slot. In some examples, the one or more reference signals further include at least a second reference signal associated with the second interior symbol within the second sub-slot of the second time slot.

In some examples, to support transmitting the one or more reference signals, the reference signal transmission component 725 is capable of, configured to, or operable to support a means for transmitting the one or more reference signals to the second wireless device during a third time slot prior to the first time slot.

In some examples, the one or more reference signals are DMRSs.

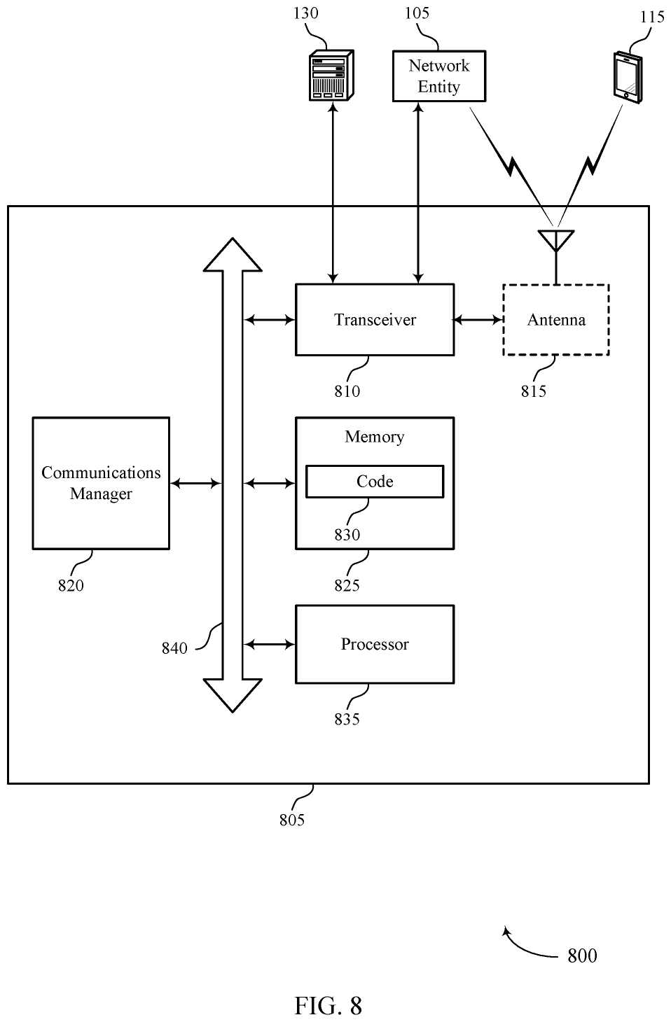

FIG. 8 shows a diagram of a system 800 including a device 805 that supports sub-slot precoding for wireless communications in accordance with one or more aspects of the present disclosure. The device 805 may be an example of or include the components of a device 505, a device 605, or a network entity 105 as described herein. The device 805 may communicate with one or more network entities 105, one or more UEs 115, or any combination thereof, which may include communications over one or more wired interfaces, over one or more wireless interfaces, or any combination thereof. The device 805 may include components that support outputting and obtaining communications, such as a communications manager 820, a transceiver 810, an antenna 815, at least one memory 825, code 830, and at least one processor 835. These components may be in electronic communication or otherwise coupled (e.g., operatively, communicatively, functionally, electronically, electrically) via one or more buses (e.g., a bus 840).

The transceiver 810 may support bi-directional communications via wired links, wireless links, or both as described herein. In some examples, the transceiver 810 may include a wired transceiver and may communicate bi-directionally with another wired transceiver. Additionally, or alternatively, in some examples, the transceiver 810 may include a wireless transceiver and may communicate bi-directionally with another wireless transceiver. In some examples, the device 805 may include one or more antennas 815, which may be capable of transmitting or receiving wireless transmissions (e.g., concurrently). The transceiver 810 may also include a modem to modulate signals, to provide the modulated signals for transmission (e.g., by one or more antennas 815, by a wired transmitter), to receive modulated signals (e.g., from one or more antennas 815, from a wired receiver), and to demodulate signals. In some implementations, the transceiver 810 may include one or more interfaces, such as one or more interfaces coupled with the one or more antennas 815 that are configured to support various receiving or obtaining operations, or one or more interfaces coupled with the one or more antennas 815 that are configured to support various transmitting or outputting operations, or a combination thereof. In some implementations, the transceiver 810 may include or be configured for coupling with one or more processors or one or more memory components that are operable to perform or support operations based on received or obtained information or signals, or to generate information or other signals for transmission or other outputting, or any combination thereof. In some implementations, the transceiver 810, or the transceiver 810 and the one or more antennas 815, or the transceiver 810 and the one or more antennas 815 and one or more processors or one or more memory components (e.g., the at least one processor 835, the at least one memory 825, or both), may be included in a chip or chip assembly that is installed in the device 805. In some examples, the transceiver 810 may be operable to support communications via one or more communications links (e.g., a communication link 125, a backhaul communication link 120, a midhaul communication link 162, a fronthaul communication link 168).

The at least one memory 825 may include RAM, ROM, or any combination thereof. The at least one memory 825 may store computer-readable, computer-executable code 830 including instructions that, when executed by one or more of the at least one processor 835, cause the device 805 to perform various functions described herein. The code 830 may be stored in a non-transitory computer-readable medium such as system memory or another type of memory. In some cases, the code 830 may not be directly executable by a processor of the at least one processor 835 but may cause a computer (e.g., when compiled and executed) to perform functions described herein. In some cases, the at least one memory 825 may contain, among other things, a BIOS which may control basic hardware or software operation such as the interaction with peripheral components or devices. In some examples, the at least one processor 835 may include multiple processors and the at least one memory 825 may include multiple memories. One or more of the multiple processors may be coupled with one or more of the multiple memories which may, individually or collectively, be configured to perform various functions herein (for example, as part of a processing system).

The at least one processor 835 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 835 may be configured to operate a memory array using a memory controller. In some other cases, a memory controller may be integrated into one or more of the at least one processor 835. The at least one processor 835 may be configured to execute computer-readable instructions stored in a memory (e.g., one or more of the at least one memory 825) to cause the device 805 to perform various functions (e.g., functions or tasks supporting sub-slot precoding for wireless communications). For example, the device 805 or a component of the device 805 may include at least one processor 835 and at least one memory 825 coupled with one or more of the at least one processor 835, the at least one processor 835 and the at least one memory 825 configured to perform various functions described herein. The at least one processor 835 may be an example of a cloud-computing platform (e.g., one or more physical nodes and supporting software such as operating systems, virtual machines, or container instances) that may host the functions (e.g., by executing code 830) to perform the functions of the device 805. The at least one processor 835 may be any one or more suitable processors capable of executing scripts or instructions of one or more software programs stored in the device 805 (such as within one or more of the at least one memory 825). In some examples, the at least one processor 835 may include multiple processors and the at least one memory 825 may include multiple memories. One or more of the multiple processors may be coupled with one or more of the multiple memories, which may, individually or collectively, be configured to perform various functions herein. In some examples, the at least one processor 835 may be a component of a processing system, which may refer to a system (such as a series) of machines, circuitry (including, for example, one or both of processor circuitry (which may include the at least one processor 835) and memory circuitry (which may include the at least one memory 825)), or components, that receives or obtains inputs and processes the inputs to produce, generate, or obtain a set of outputs. The processing system may be configured to perform one or more of the functions described herein. As such, the at least one processor 835 or a processing system including the at least one processor 835 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 825 or otherwise, to perform one or more of the functions described herein.

In some examples, a bus 840 may support communications of (e.g., within) a protocol layer of a protocol stack. In some examples, a bus 840 may support communications associated with a logical channel of a protocol stack (e.g., between protocol layers of a protocol stack), which may include communications performed within a component of the device 805, or between different components of the device 805 that may be co-located or located in different locations (e.g., where the device 805 may refer to a system in which one or more of the communications manager 820, the transceiver 810, the at least one memory 825, the code 830, and the at least one processor 835 may be located in one of the different components or divided between different components).

In some examples, the communications manager 820 may manage aspects of communications with a core network 130 (e.g., via one or more wired or wireless backhaul links). For example, the communications manager 820 may manage the transfer of data communications for client devices, such as one or more UEs 115. In some examples, the communications manager 820 may manage communications with other network entities 105, and may include a controller or scheduler for controlling communications with UEs 115 in cooperation with other network entities 105. In some examples, the communications manager 820 may support an X2 interface within an LTE/LTE-A wireless communications network technology to provide communication between network entities 105.

For example, the communications manager 820 is capable of, configured to, or operable to support a means for transmitting one or more reference signals to a second wireless device. The communications manager 820 is capable of, configured to, or operable to support a means for receiving, from the second wireless device, in response to the one or more reference signals, channel estimation information that is associated with observed channel conditions for the second wireless device during a first time slot. The communications manager 820 is capable of, configured to, or operable to support a means for determining, based on the received channel estimation information, multiple channel condition predictions for the second wireless device, the multiple channel condition predictions associated with a second time slot that is subsequent to the first time slot, where the multiple channel condition predictions include a first channel condition prediction that is for a first sub-slot of the second time slot and a second channel condition prediction that is for a second sub-slot of the second time slot. The communications manager 820 is capable of, configured to, or operable to support a means for communicating with the second wireless device during the second time slot using multiple precoders, where the multiple precoders include a first precoder for one or more first transmissions during the first sub-slot, the first precoder based on the first channel condition prediction, and a second precoder for one or more second transmissions during the second sub-slot, the second precoder based least in part on the second channel condition prediction.

By including or configuring the communications manager 820 in accordance with examples as described herein, the device 805 may support techniques for improved communication reliability, reduced latency, improved user experience related to reduced processing, more efficient utilization of communication resources, and improved coordination between devices.

In some examples, the communications manager 820 may be configured to perform various operations (e.g., receiving, obtaining, monitoring, outputting, transmitting) using or otherwise in cooperation with the transceiver 810, the one or more antennas 815 (e.g., where applicable), or any combination thereof. Although the communications manager 820 is illustrated as a separate component, in some examples, one or more functions described with reference to the communications manager 820 may be supported by or performed by the transceiver 810, one or more of the at least one processor 835, one or more of the at least one memory 825, the code 830, or any combination thereof (for example, by a processing system including at least a portion of the at least one processor 835, the at least one memory 825, the code 830, or any combination thereof). For example, the code 830 may include instructions executable by one or more of the at least one processor 835 to cause the device 805 to perform various aspects of sub-slot precoding for wireless communications as described herein, or the at least one processor 835 and the at least one memory 825 may be otherwise configured to, individually or collectively, perform or support such operations.

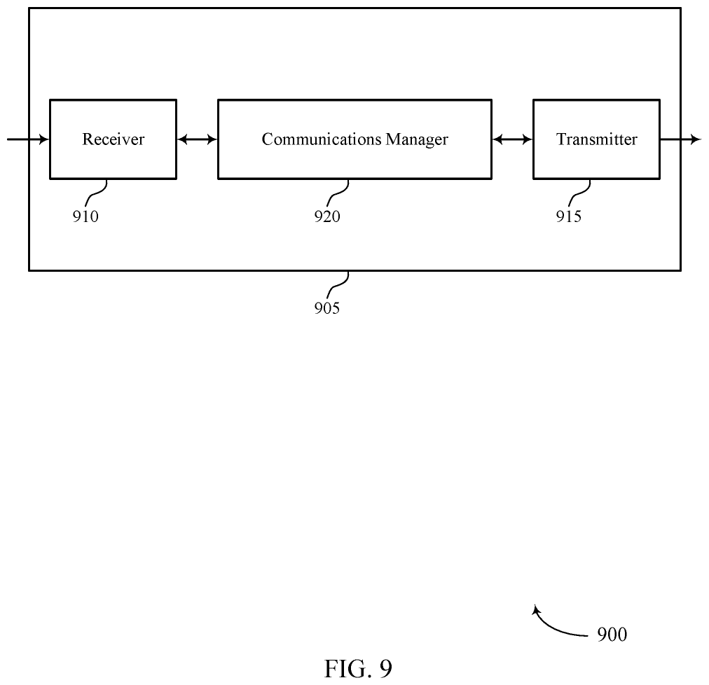

FIG. 9 shows a block diagram 900 of a device 905 that supports sub-slot precoding for wireless communications in accordance with one or more aspects of the present disclosure. The device 905 may be an example of aspects of a UE 115 as described herein. The device 905 may include a receiver 910, a transmitter 915, and a communications manager 920. The device 905, or one or more components of the device 905 (e.g., the receiver 910, the transmitter 915, and the communications manager 920), may include at least one processor, which may be coupled with at least one memory, to, individually or collectively, support or enable the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to sub-slot precoding for wireless communications). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to sub-slot precoding for wireless communications). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of sub-slot precoding for wireless communications as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor. If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

For example, the communications manager 920 is capable of, configured to, or operable to support a means for receiving one or more reference signals from a first wireless device. The communications manager 920 is capable of, configured to, or operable to support a means for transmitting, to the first wireless device, channel estimation information that is based on the one or more reference signals and is associated with observed channel conditions for the second wireless device during a first time slot. The communications manager 920 is capable of, configured to, or operable to support a means for receiving, from the first wireless device during a first sub-slot within a second time slot that is subsequent to the first time slot, one or more first transmissions precoded according to a first precoder that is based on the channel estimation information and a first channel condition prediction associated with the first sub-slot. The communications manager 920 is capable of, configured to, or operable to support a means for receiving, from the first wireless device during a second sub-slot within the second time slot, one or more second transmissions precoded according to a second precoder that is based on the channel estimation information and a second channel condition prediction associated with the second sub-slot.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced processing and more efficient utilization of communication resources.

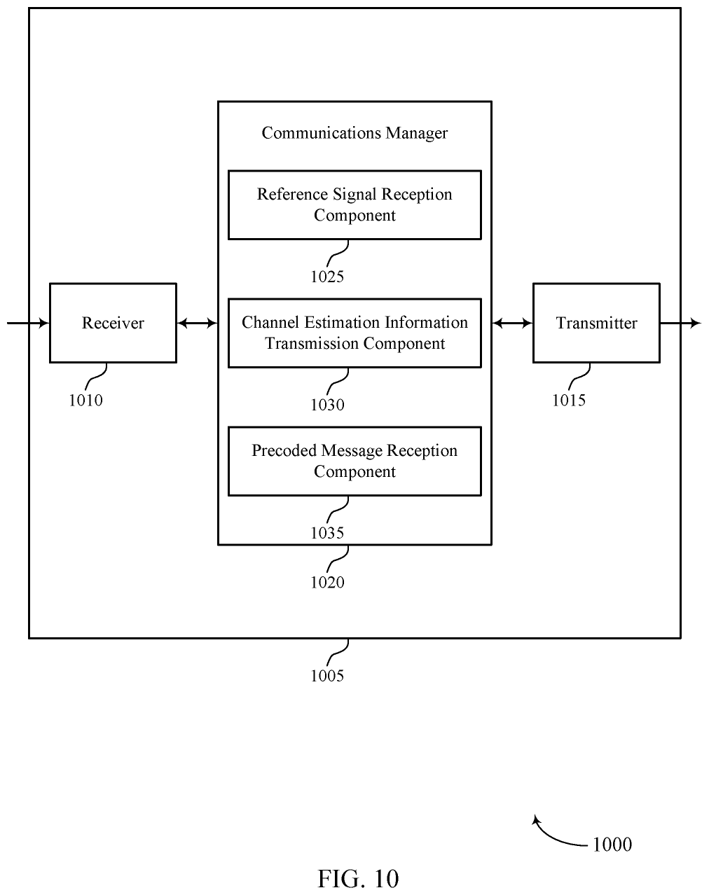

FIG. 10 shows a block diagram 1000 of a device 1005 that supports sub-slot precoding for wireless communications in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to support the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to sub-slot precoding for wireless communications). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to sub-slot precoding for wireless communications). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of sub-slot precoding for wireless communications as described herein. For example, the communications manager 1020 may include a reference signal reception component 1025, a channel estimation information transmission component 1030, a precoded message reception component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The reference signal reception component 1025 is capable of, configured to, or operable to support a means for receiving one or more reference signals from a first wireless device. The channel estimation information transmission component 1030 is capable of, configured to, or operable to support a means for transmitting, to the first wireless device, channel estimation information that is based on the one or more reference signals and is associated with observed channel conditions for the second wireless device during a first time slot. The precoded message reception component 1035 is capable of, configured to, or operable to support a means for receiving, from the first wireless device during a first sub-slot within a second time slot that is subsequent to the first time slot, one or more first transmissions precoded according to a first precoder that is based on the channel estimation information and a first channel condition prediction associated with the first sub-slot. The precoded message reception component 1035 is capable of, configured to, or operable to support a means for receiving, from the first wireless device during a second sub-slot within the second time slot, one or more second transmissions precoded according to a second precoder that is based on the channel estimation information and a second channel condition prediction associated with the second sub-slot.

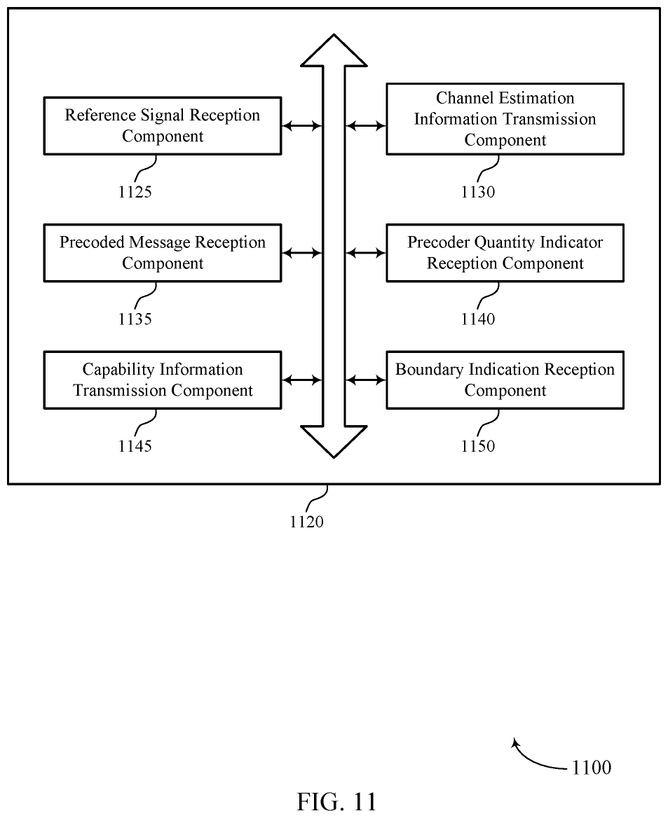

FIG. 11 shows a block diagram 1100 of a communications manager 1120 that supports sub-slot precoding for wireless communications in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of sub-slot precoding for wireless communications as described herein. For example, the communications manager 1120 may include a reference signal reception component 1125, a channel estimation information transmission component 1130, a precoded message reception component 1135, a precoder quantity indicator reception component 1140, a capability information transmission component 1145, a boundary indication reception component 1150, or any combination thereof. Each of these components, or components or subcomponents thereof (e.g., one or more processors, one or more memories), may communicate, directly or indirectly, with one another (e.g., via one or more buses).

The reference signal reception component 1125 is capable of, configured to, or operable to support a means for receiving one or more reference signals from a first wireless device. The channel estimation information transmission component 1130 is capable of, configured to, or operable to support a means for transmitting, to the first wireless device, channel estimation information that is based on the one or more reference signals and is associated with observed channel conditions for the second wireless device during a first time slot. The precoded message reception component 1135 is capable of, configured to, or operable to support a means for receiving, from the first wireless device during a first sub-slot within a second time slot that is subsequent to the first time slot, one or more first transmissions precoded according to a first precoder that is based on the channel estimation information and a first channel condition prediction associated with the first sub-slot. In some examples, the precoded message reception component 1135 is capable of, configured to, or operable to support a means for receiving, from the first wireless device during a second sub-slot within the second time slot, one or more second transmissions precoded according to a second precoder that is based on the channel estimation information and a second channel condition prediction associated with the second sub-slot.

In some examples, the precoder quantity indicator reception component 1140 is capable of, configured to, or operable to support a means for receiving, from the first wireless device, an indication of a quantity of precoders associated with transmissions from the first wireless device to the first wireless device during the second time slot, where the indicated quantity of precoders is equal to a quantity of sub-slots within the second time slot.

In some examples, a boundary between the first sub-slot and the second sub-slot is based on the quantity of precoders, the boundary being between an end symbol of the first sub-slot and a start symbol of the second time slot.

In some examples, the boundary indication reception component 1150 is capable of, configured to, or operable to support a means for receiving, from the first wireless device, an indication of the boundary between the first sub-slot and the second sub-slot.

In some examples, to support receiving the indication of the quantity of precoders, the precoder quantity indicator reception component 1140 is capable of, configured to, or operable to support a means for receiving the indication of the quantity of precoders via radio resource control signaling or via downlink control information.

In some examples, multiple precoders being associated with transmissions during the second time slot is based at least in part on a velocity of the second wireless device satisfying a threshold velocity, the multiple precoders including the first precoder and the second precoder, and the transmissions during the second time slot including the one or more first transmissions and the one or more second transmissions.

In some examples, the capability information transmission component 1145 is capable of, configured to, or operable to support a means for transmitting, to the first wireless device, capability information indicating support by the second wireless device for communicating in accordance with two or more precoders within a slot, where the one or more first transmissions are precoded according to the first precoder and the one or more second transmissions are precoded according to the second precoder (e.g., multiple precoders are used for transmissions within the second slot) based on the capability information.

In some examples, the precoded message reception component 1135 is capable of, configured to, or operable to support a means for receiving, from the first wireless device during a third sub-slot within the second time slot, one or more third transmissions precoded according to a third precoder that is based on the channel estimation information and a third channel condition prediction associated with the third sub-slot.

In some examples, the first channel condition prediction is based on predicted channel conditions for the second wireless device during a first interior symbol within the first sub-slot of the second time slot, the first interior symbol being between at least two other symbols of the first sub-slot. In some examples, the second channel condition prediction is based on predicted channel conditions for the second wireless device during a second interior symbol within the second sub-slot of the second time slot, the second interior symbol being between at least two other symbols of the second sub-slot.

In some examples, the one or more reference signals include at least a first reference signal associated with the first interior symbol within the first sub-slot of the second time slot. In some examples, the one or more reference signals further include at least a second reference signal associated with the second interior symbol within the second sub-slot of the second time slot.

In some examples, to support receiving the one or more reference signals, the reference signal reception component 1125 is capable of, configured to, or operable to support a means for receiving the one or more reference signals from the first wireless device during a third time slot prior to the first time slot.

In some examples, the one or more reference signals are DMRSs.

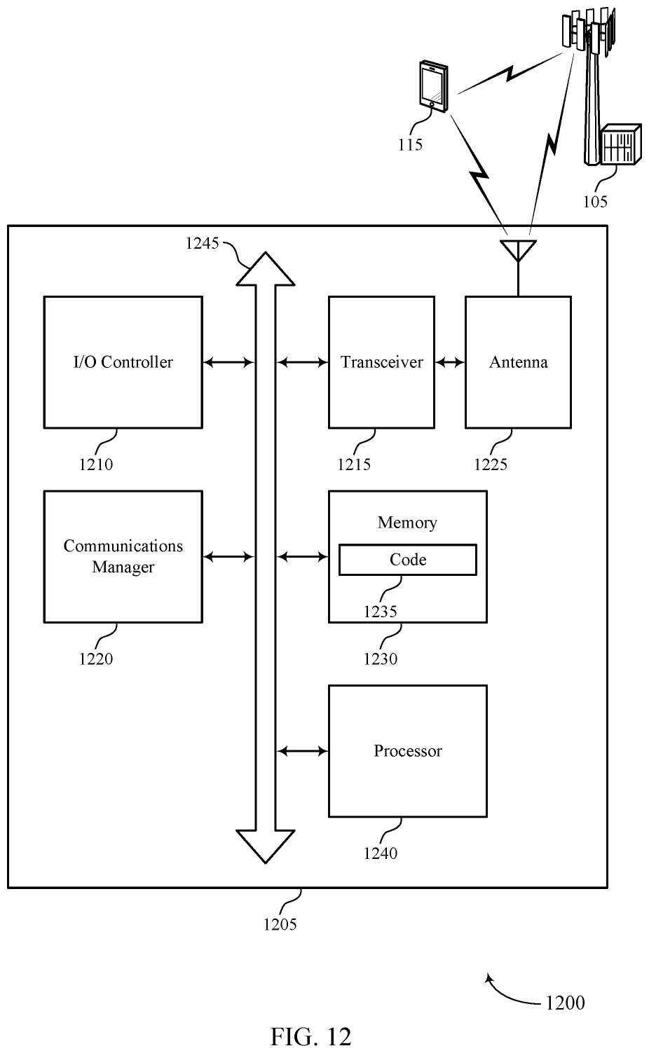

FIG. 12 shows a diagram of a system 1200 including a device 1205 that supports sub-slot precoding for wireless communications in accordance with one or more aspects of the present disclosure. The device 1205 may be an example of or include the components of a device 905, a device 1005, or a UE 115 as described herein. The device 1205 may communicate (e.g., wirelessly) with one or more network entities 105, one or more UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, at least one memory 1230, code 1235, and at least one processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of one or more processors, such as the at least one processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The at least one memory 1230 may include random access memory (RAM) and read-only memory (ROM). The at least one memory 1230 may store computer-readable, computer-executable code 1235 including instructions that, when executed by the at least one processor 1240, cause the device 1205 to perform various functions described herein. The code 1235 may be stored in a non-transitory computer-readable medium such as system memory or another type of memory. In some cases, the code 1235 may not be directly executable by the at least one processor 1240 but may cause a computer (e.g., when compiled and executed) to perform functions described herein. In some cases, the at least one memory 1230 may contain, among other things, a basic I/O system (BIOS) which may control basic hardware or software operation such as the interaction with peripheral components or devices.

The at least one processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1240 may be configured to operate a memory array using a memory controller. In some other cases, a memory controller may be integrated into the at least one processor 1240. The at least one processor 1240 may be configured to execute computer-readable instructions stored in a memory (e.g., the at least one memory 1230) to cause the device 1205 to perform various functions (e.g., functions or tasks supporting sub-slot precoding for wireless communications). For example, the device 1205 or a component of the device 1205 may include at least one processor 1240 and at least one memory 1230 coupled with or to the at least one processor 1240, the at least one processor 1240 and at least one memory 1230 configured to perform various functions described herein. In some examples, the at least one processor 1240 may include multiple processors and the at least one memory 1230 may include multiple memories. One or more of the multiple processors may be coupled with one or more of the multiple memories, which may, individually or collectively, be configured to perform various functions herein. In some examples, the at least one processor 1240 may be a component of a processing system, which may refer to a system (such as a series) of machines, circuitry (including, for example, one or both of processor circuitry (which may include the at least one processor 1240) and memory circuitry (which may include the at least one memory 1230)), or components, that receives or obtains inputs and processes the inputs to produce, generate, or obtain a set of outputs. The processing system may be configured to perform one or more of the functions described herein. As such, the at least one processor 1240 or a processing system including the at least one processor 1240 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1230 or otherwise, to perform one or more of the functions described herein.

For example, the communications manager 1220 is capable of, configured to, or operable to support a means for receiving one or more reference signals from a first wireless device. The communications manager 1220 is capable of, configured to, or operable to support a means for transmitting, to the first wireless device, channel estimation information that is based on the one or more reference signals and is associated with observed channel conditions for the second wireless device during a first time slot. The communications manager 1220 is capable of, configured to, or operable to support a means for receiving, from the first wireless device during a first sub-slot within a second time slot that is subsequent to the first time slot, one or more first transmissions precoded according to a first precoder that is based on the channel estimation information and a first channel condition prediction associated with the first sub-slot. The communications manager 1220 is capable of, configured to, or operable to support a means for receiving, from the first wireless device during a second sub-slot within the second time slot, one or more second transmissions precoded according to a second precoder that is based on the channel estimation information and a second channel condition prediction associated with the second sub-slot.

By including or configuring the communications manager 1220 in accordance with examples as described herein, the device 1205 may support techniques for improved communication reliability, reduced latency, improved user experience related to reduced processing, more efficient utilization of communication resources, improved coordination between devices, and improved utilization of processing capability.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the at least one processor 1240, the at least one memory 1230, the code 1235, or any combination thereof. For example, the code 1235 may include instructions executable by the at least one processor 1240 to cause the device 1205 to perform various aspects of sub-slot precoding for wireless communications as described herein, or the at least one processor 1240 and the at least one memory 1230 may be otherwise configured to, individually or collectively, perform or support such operations.

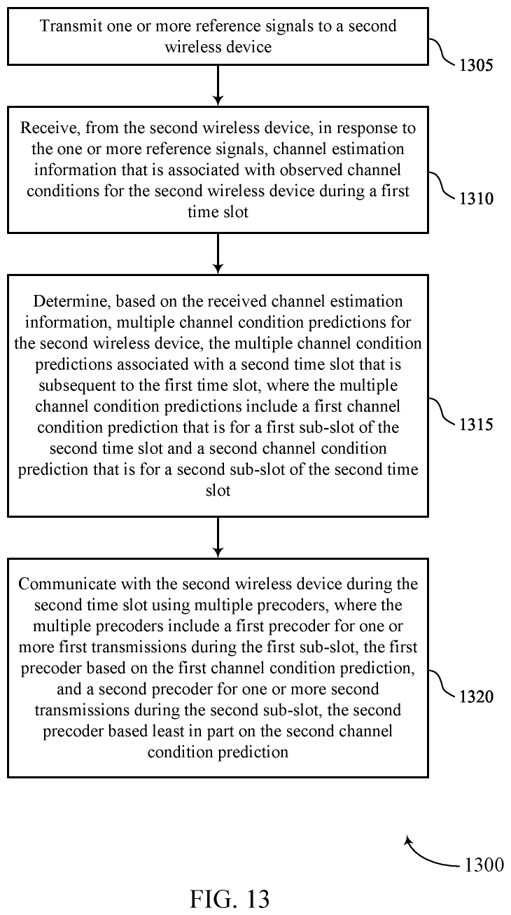

FIG. 13 shows a flowchart illustrating a method 1300 that supports sub-slot precoding for wireless communications in accordance with aspects of the present disclosure. The operations of the method 1300 may be implemented by a network entity or its components as described herein. For example, the operations of the method 1300 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1305, the method may include transmitting one or more reference signals to a second wireless device. The operations of block 1305 may be performed in accordance with examples as disclosed herein. In some examples, aspects of the operations of 1305 may be performed by a reference signal transmission component 725 as described with reference to FIG. 7.

At 1310, the method may include receiving, from the second wireless device, in response to the one or more reference signals, channel estimation information that is associated with observed channel conditions for the second wireless device during a first time slot. The operations of block 1310 may be performed in accordance with examples as disclosed herein. In some examples, aspects of the operations of 1310 may be performed by a channel estimation information reception component 730 as described with reference to FIG. 7.

At 1315, the method may include determining, based on the received channel estimation information, multiple channel condition predictions for the second wireless device, the multiple channel condition predictions associated with a second time slot that is subsequent to the first time slot, where the multiple channel condition predictions include a first channel condition prediction that is for a first sub-slot of the second time slot and a second channel condition prediction that is for a second sub-slot of the second time slot. The operations of block 1315 may be performed in accordance with examples as disclosed herein. In some examples, aspects of the operations of 1315 may be performed by a channel prediction component 735 as described with reference to FIG. 7.

At 1320, the method may include communicating with the second wireless device during the second time slot using multiple precoders, where the multiple precoders include a first precoder for one or more first transmissions during the first sub-slot, the first precoder based on the first channel condition prediction, and a second precoder for one or more second transmissions during the second sub-slot, the second precoder based least in part on the second channel condition prediction. The operations of block 1320 may be performed in accordance with examples as disclosed herein. In some examples, aspects of the operations of 1320 may be performed by a message transmission component 740 as described with reference to FIG. 7.

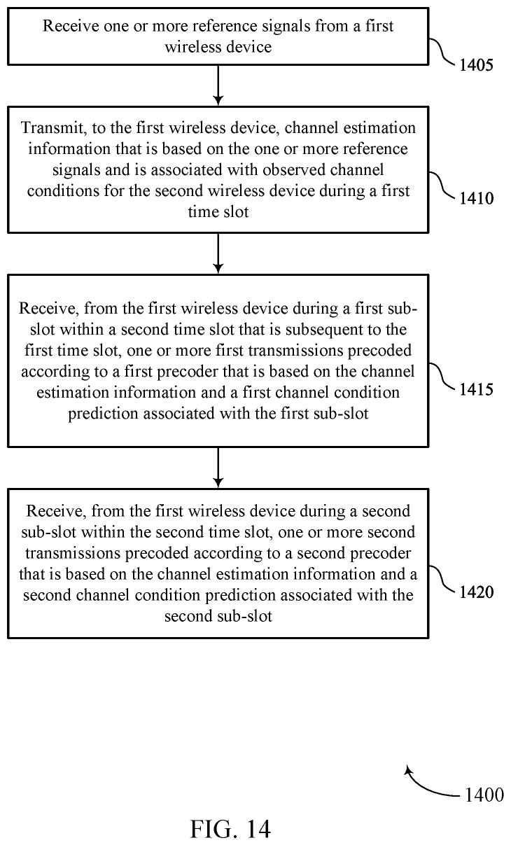

FIG. 14 shows a flowchart illustrating a method 1400 that supports sub-slot precoding for wireless communications in accordance with aspects of the present disclosure. The operations of the method 1400 may be implemented by a UE or its components as described herein. For example, the operations of the method 1400 may be performed by a UE 115 as described with reference to FIGS. 1 through 4 and 9 through 12. In some examples, a UE may execute a set of instructions to control the functional elements of the UE to perform the described functions. Additionally, or alternatively, the UE may perform aspects of the described functions using special-purpose hardware.

At 1405, the method may include receiving one or more reference signals from a first wireless device. The operations of block 1405 may be performed in accordance with examples as disclosed herein. In some examples, aspects of the operations of 1405 may be performed by a reference signal reception component 1125 as described with reference to FIG. 11.

At 1410, the method may include transmitting, to the first wireless device, channel estimation information that is based on the one or more reference signals and is associated with observed channel conditions for the second wireless device during a first time slot. The operations of block 1410 may be performed in accordance with examples as disclosed herein. In some examples, aspects of the operations of 1410 may be performed by a channel estimation information transmission component 1130 as described with reference to FIG. 11.

At 1415, the method may include receiving, from the first wireless device during a first sub-slot within a second time slot that is subsequent to the first time slot, one or more first transmissions precoded according to a first precoder that is based on the channel estimation information and a first channel condition prediction associated with the first sub-slot. The operations of block 1415 may be performed in accordance with examples as disclosed herein. In some examples, aspects of the operations of 1415 may be performed by a precoded message reception component 1135 as described with reference to FIG. 11.

At 1420, the method may include receiving, from the first wireless device during a second sub-slot within the second time slot, one or more second transmissions precoded according to a second precoder that is based on the channel estimation information and a second channel condition prediction associated with the second sub-slot. The operations of block 1420 may be performed in accordance with examples as disclosed herein. In some examples, aspects of the operations of 1420 may be performed by a precoded message reception component 1135 as described with reference to FIG. 11.

The following provides an overview of aspects of the present disclosure:

Aspect 1: A method for wireless communications at a first wireless device, the method comprising: transmitting one or more reference signals to a second wireless device; receiving, from the second wireless device, in response to the one or more reference signals, channel estimation information that is associated with observed channel conditions for the second wireless device during a first time slot; determining, based at least in part on the received channel estimation information, multiple channel condition predictions for the second wireless device, the multiple channel condition predictions associated with a second time slot that is subsequent to the first time slot, wherein the multiple channel condition predictions comprise a first channel condition prediction that is for a first sub-slot of the second time slot and a second channel condition prediction that is for a second sub-slot of the second time slot; and communicating with the second wireless device during the second time slot using multiple precoders, wherein the multiple precoders comprise a first precoder for one or more first transmissions during the first sub-slot, the first precoder based at least in part on the first channel condition prediction, and a second precoder for one or more second transmissions during the second sub-slot, the second precoder based least in part on the second channel condition prediction.

Aspect 2: The method of aspect 1, further comprising: transmitting, to the second wireless device, an indication of a quantity of precoders associated with transmissions from the first wireless device to the second wireless device during the second time slot, wherein the indicated quantity of precoders is equal to a quantity of channel condition predictions included in the multiple channel condition predictions.

Aspect 3: The method of aspect 2, wherein a boundary between the first sub-slot and the second sub-slot is based at least in part on the quantity of precoders, the boundary being between an end symbol of the first sub-slot and a start symbol of the second sub-slot.

Aspect 4: The method of aspect 3, further comprising: transmitting, to the second wireless device, an indication of the boundary between the first sub-slot and the second sub-slot.

Aspect 5: The method of any of aspects 2 through 4, wherein transmitting the indication of the quantity of precoders comprises: transmitting the indication of the quantity of precoders via radio resource control signaling or via downlink control information.

Aspect 6: The method of any of aspects 1 through 5, wherein using the multiple precoders to communicate with the second wireless device during the second time slot is based at least in part on a velocity of the second wireless device satisfying a threshold velocity.

Aspect 7: The method of any of aspects 1 through 6, further comprising: receiving, from the second wireless device, capability information indicating support by the second wireless device for communicating in accordance with two or more precoders within a slot, wherein determining the multiple channel condition predictions is based at least in part on receiving the capability information.

Aspect 8: The method of any of aspects 1 through 7, wherein the multiple channel condition predictions further comprise a third channel condition prediction that is for a third sub-slot of the second time slot.

Aspect 9: The method of any of aspects 1 through 8, wherein the first channel condition prediction is based at least in part on predicted channel conditions for the second wireless device during a first interior symbol within the first sub-slot of the second time slot, the first interior symbol being between at least two other symbols of the first sub-slot; and the second channel condition prediction is based at least in part on predicted channel conditions for the second wireless device during a second interior symbol within the second sub-slot of the second time slot, the second interior symbol being between at least two other symbols of the second sub-slot.

Aspect 10: The method of aspect 9, wherein the one or more reference signals comprise at least a first reference signal associated with the first interior symbol within the first sub-slot of the second time slot; and the one or more reference signals further comprise at least a second reference signal associated with the second interior symbol within the second sub-slot of the second time slot.

Aspect 11: The method of any of aspects 1 through 10, wherein transmitting the one or more reference signals comprises: transmitting the one or more reference signals to the second wireless device during a third time slot prior to the first time slot.

Aspect 12: The method of any of aspects 1 through 11, wherein the one or more reference signals are DMRSs.

Aspect 13: A method for wireless communications at a second wireless device, the method comprising: receiving one or more reference signals from a first wireless device; transmitting, to the first wireless device, channel estimation information that is based at least in part on the one or more reference signals and is associated with observed channel conditions for the second wireless device during a first time slot; receiving, from the first wireless device during a first sub-slot within a second time slot that is subsequent to the first time slot, one or more first transmissions precoded according to a first precoder that is based at least in part on the channel estimation information and a first channel condition prediction associated with the first sub-slot; and receiving, from the first wireless device during a second sub-slot within the second time slot, one or more second transmissions precoded according to a second precoder that is based at least in part on the channel estimation information and a second channel condition prediction associated with the second sub-slot.

Aspect 14: The method of aspect 13, further comprising: receiving, from the first wireless device, an indication of a quantity of precoders associated with transmissions from the first wireless device to the first wireless device during the second time slot, wherein the indicated quantity of precoders is equal to a quantity of sub-slots within the second time slot.

Aspect 15: The method of aspect 14, wherein a boundary between the first sub-slot and the second sub-slot is based at least in part on the quantity of precoders, the boundary being between an end symbol of the first sub-slot and a start symbol of the second time slot.

Aspect 16: The method of aspect 15, further comprising: receiving, from the first wireless device, an indication of the boundary between the first sub-slot and the second sub-slot.

Aspect 17: The method of any of aspects 14 through 16, wherein receiving the indication of the quantity of precoders comprises: receiving the indication of the quantity of precoders via radio resource control signaling or via downlink control information.

Aspect 18: The method of any of aspects 13 through 16, wherein multiple precoders being associated with transmissions during the second time slot is based at least in part on a velocity of the second wireless device satisfying a threshold velocity, the multiple precoders comprising the first precoder and the second precoder, and the transmissions during the second time slot comprising the one or more first transmissions and the one or more second transmissions.

Aspect 19: The method of any of aspects 13 through 18, further comprising: transmitting, to the first wireless device, capability information indicating support by the second wireless device for communicating in accordance with two or more precoders within a slot, wherein the one or more first transmissions are precoded according to the first precoder and the one or more second transmissions are precoded according to the second precoder based at least in part on the capability information.

Aspect 20: The method of any of aspects 13 through 19, further comprising: receiving, from the first wireless device during a third sub-slot within the second time slot, one or more third transmissions precoded according to a third precoder that is based at least in part on the channel estimation information and a third channel condition prediction associated with the third sub-slot.

Aspect 21: The method of any of aspects 13 through 20, wherein the first channel condition prediction is based at least in part on predicted channel conditions for the second wireless device during a first interior symbol within the first sub-slot of the second time slot, the first interior symbol being between at least two other symbols of the first sub-slot; and the second channel condition prediction is based at least in part on predicted channel conditions for the second wireless device during a second interior symbol within the second sub-slot of the second time slot, the second interior symbol being between at least two other symbols of the second sub-slot.

Aspect 22: The method of aspect 21, wherein the one or more reference signals comprise at least a first reference signal associated with the first interior symbol within the first sub-slot of the second time slot; and the one or more reference signals further comprise at least a second reference signal associated with the second interior symbol within the second sub-slot of the second time slot.

Aspect 23: The method of any of aspects 13 through 22, wherein receiving the one or more reference signals comprises: receiving the one or more reference signals from the first wireless device during a third time slot prior to the first time slot.

Aspect 24: The method of any of aspects 13 through 23, wherein the one or more reference signals are DMRSs.

Aspect 25: A first wireless device comprising one or more memories storing processor-executable code, and one or more processors coupled with the one or more memories and individually or collectively operable to execute the code to cause the first wireless device to perform a method of any of aspects 1 through 12.

Aspect 26: A first wireless device comprising at least one means for performing a method of any of aspects 1 through 12.

Aspect 27: A non-transitory computer-readable medium storing code the code comprising instructions executable by a processor to perform a method of any of aspects 1 through 12.

Aspect 28: A second wireless device comprising one or more memories storing processor-executable code, and one or more processors coupled with the one or more memories and individually or collectively operable to execute the code to cause the second wireless device to perform a method of any of aspects 13 through 24.

Aspect 29: A second wireless device comprising at least one means for performing a method of any of aspects 13 through 24.

Aspect 30: A non-transitory computer-readable medium storing code the code comprising instructions executable by a processor to perform a method of any of aspects 13 through 24.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first wireless device, comprising:
one or more memories storing processor-executable code; and
one or more processors coupled with the one or more memories and individually or collectively operable to execute the code to cause the first wireless device to:
transmit one or more reference signals to a second wireless device;
receive, from the second wireless device, in response to the one or more reference signals, channel estimation information that is associated with observed channel conditions for the second wireless device during a first time slot;
determine, based at least in part on the received channel estimation information, multiple channel condition predictions for the second wireless device, the multiple channel condition predictions associated with a second time slot that is subsequent to the first time slot, wherein the multiple channel condition predictions comprise a first channel condition prediction that is for a first sub-slot of the second time slot and a second channel condition prediction that is for a second sub-slot of the second time slot; and
communicate with the second wireless device during the second time slot using multiple precoders, wherein the multiple precoders comprise a first precoder for one or more first transmissions during the first sub-slot, the first precoder based at least in part on the first channel condition prediction, and a second precoder for one or more second transmissions during the second sub-slot, the second precoder based least in part on the second channel condition prediction.

2. The first wireless device of claim 1, wherein the one or more processors are individually or collectively further operable to execute the code to cause the first wireless device to:
transmit, to the second wireless device, an indication of a quantity of precoders associated with transmissions from the first wireless device to the second wireless device during the second time slot, wherein the indicated quantity of precoders is equal to a quantity of channel condition predictions included in the multiple channel condition predictions.

3. The first wireless device of claim 2, wherein a boundary between the first sub-slot and the second sub-slot is based at least in part on the quantity of precoders, the boundary being between an end symbol of the first sub-slot and a start symbol of the second sub-slot.

4. The first wireless device of claim 3, wherein the one or more processors are individually or collectively further operable to execute the code to cause the first wireless device to:
transmit, to the second wireless device, an indication of the boundary between the first sub-slot and the second sub-slot.

5. The first wireless device of claim 1, wherein the one or more processors are individually or collectively operable to execute the code to cause the first wireless device to use the multiple precoders to communicate with the second wireless device during the second time slot based at least in part on a velocity of the second wireless device satisfying a threshold velocity.

6. The first wireless device of claim 1, wherein the one or more processors are individually or collectively further operable to execute the code to cause the first wireless device to:
receive, from the second wireless device, capability information indicating support by the second wireless device for communicating in accordance with two or more precoders within a slot, wherein the one or more processors are individually or collectively operable to execute the code to cause the first wireless device to determine multiple channel condition predictions based at least in part on receiving the capability information.

7. The first wireless device of claim 1, wherein the multiple channel condition predictions further comprise a third channel condition prediction that is for a third sub-slot of the second time slot.

8. The first wireless device of claim 1, wherein:
the first channel condition prediction is based at least in part on predicted channel conditions for the second wireless device during a first interior symbol within the first sub-slot of the second time slot, the first interior symbol being between at least two other symbols of the first sub-slot; and
the second channel condition prediction is based at least in part on predicted channel conditions for the second wireless device during a second interior symbol within the second sub-slot of the second time slot, the second interior symbol being between at least two other symbols of the second sub-slot.

9. The first wireless device of claim 1, wherein, to transmit the one or more reference signals, the one or more processors are individually or collectively operable to execute the code to cause the first wireless device to:
transmit the one or more reference signals to the second wireless device during a third time slot prior to the first time slot.

10. A second wireless device, comprising:
one or more memories storing processor-executable code; and
one or more processors coupled with the one or more memories and individually or collectively operable to execute the code to cause the second wireless device to:
receive one or more reference signals from a first wireless device;
transmit, to the first wireless device, channel estimation information that is based at least in part on the one or more reference signals and is associated with observed channel conditions for the second wireless device during a first time slot;
receive, from the first wireless device during a first sub-slot within a second time slot that is subsequent to the first time slot, one or more first transmissions precoded according to a first precoder that is based at least in part on the channel estimation information and a first channel condition prediction associated with the first sub-slot; and
receive, from the first wireless device during a second sub-slot within the second time slot, one or more second transmissions precoded according to a second precoder that is based at least in part on the channel estimation information and a second channel condition prediction associated with the second sub-slot.

11. The second wireless device of claim 10, wherein the one or more processors are individually or collectively further operable to execute the code to cause the second wireless device to:
receive, from the first wireless device, an indication of a quantity of precoders associated with transmissions from the first wireless device to the first wireless device during the second time slot, wherein the indicated quantity of precoders is equal to a quantity of sub-slots within the second time slot.

12. The second wireless device of claim 11, wherein a boundary between the first sub-slot and the second sub-slot is based at least in part on the quantity of precoders, the boundary being between an end symbol of the first sub-slot and a start symbol of the second time slot.

13. The second wireless device of claim 12, wherein the one or more processors are individually or collectively further operable to execute the code to cause the second wireless device to:
receive, from the first wireless device, an indication of the boundary between the first sub-slot and the second sub-slot.

14. The second wireless device of claim 10, wherein multiple precoders being associated with transmissions during the second time slot is based at least in part on a velocity of the second wireless device satisfying a threshold velocity, the multiple precoders comprising the first precoder and the second precoder, and the transmissions during the second time slot comprising the one or more first transmissions and the one or more second transmissions.

15. The second wireless device of claim 10, wherein the one or more processors are individually or collectively further operable to execute the code to cause the second wireless device to:
transmit, to the first wireless device, capability information indicating support by the second wireless device for communicating in accordance with two or more precoders within a slot, wherein the one or more first transmissions are precoded according to the first precoder and the one or more second transmissions are precoded according to the second precoder based at least in part on the capability information.

16. The second wireless device of claim 10, wherein the one or more processors are individually or collectively further operable to execute the code to cause the second wireless device to:
receive, from the first wireless device during a third sub-slot within the second time slot, one or more third transmissions precoded according to a third precoder that is based at least in part on the channel estimation information and a third channel condition prediction associated with the third sub-slot.

17. The second wireless device of claim 10, wherein:
the first channel condition prediction is based at least in part on predicted channel conditions for the second wireless device during a first interior symbol within the first sub-slot of the second time slot, the first interior symbol being between at least two other symbols of the first sub-slot; and
the second channel condition prediction is based at least in part on predicted channel conditions for the second wireless device during a second interior symbol within the second sub-slot of the second time slot, the second interior symbol being between at least two other symbols of the second sub-slot.

18. The second wireless device of claim 10, wherein, to receive the one or more reference signals, the one or more processors are individually or collectively operable to execute the code to cause the second wireless device to:
receive the one or more reference signals from the first wireless device during a third time slot prior to the first time slot.

19. A method for wireless communications at a first wireless device, the method comprising:
transmitting one or more reference signals to a second wireless device;
receiving, from the second wireless device, in response to the one or more reference signals, channel estimation information that is associated with observed channel conditions for the second wireless device during a first time slot;
determining, based at least in part on the received channel estimation information, multiple channel condition predictions for the second wireless device, the multiple channel condition predictions associated with a second time slot that is subsequent to the first time slot, wherein the multiple channel condition predictions comprise a first channel condition prediction that is for a first sub-slot of the second time slot and a second channel condition prediction that is for a second sub-slot of the second time slot; and
communicating with the second wireless device during the second time slot using multiple precoders, wherein the multiple precoders comprise a first precoder for one or more first transmissions during the first sub-slot, the first precoder based at least in part on the first channel condition prediction, and a second precoder for one or more second transmissions during the second sub-slot, the second precoder based least in part on the second channel condition prediction.

20. The method of claim 19, further comprising:
transmitting, to the second wireless device, an indication of a quantity of precoders associated with transmissions from the first wireless device to the second wireless device during the second time slot, wherein the indicated quantity of precoders is equal to a quantity of channel condition predictions included in the multiple channel condition predictions.

21. The method of claim 20, wherein a boundary between the first sub-slot and the second sub-slot is based at least in part on the quantity of precoders, the boundary being between an end symbol of the first sub-slot and a start symbol of the second sub-slot.

22. The method of claim 21, further comprising:
transmitting, to the second wireless device, an indication of the boundary between the first sub-slot and the second sub-slot.

23. The method of claim 19, wherein using the multiple precoders to communicate with the second wireless device during the second time slot is based at least in part on a velocity of the second wireless device satisfying a threshold velocity.

24. The method of claim 19, wherein:
the first channel condition prediction is based at least in part on predicted channel conditions for the second wireless device during a first interior symbol within the first sub-slot of the second time slot, the first interior symbol being between at least two other symbols of the first sub-slot; and
the second channel condition prediction is based at least in part on predicted channel conditions for the second wireless device during a second interior symbol within the second sub-slot of the second time slot, the second interior symbol being between at least two other symbols of the second sub-slot.

25. A method for wireless communications at a second wireless device, the method comprising:
receiving one or more reference signals from a first wireless device;
transmitting, to the first wireless device, channel estimation information that is based at least in part on the one or more reference signals and is associated with observed channel conditions for the second wireless device during a first time slot;
receiving, from the first wireless device during a first sub-slot within a second time slot that is subsequent to the first time slot, one or more first transmissions precoded according to a first precoder that is based at least in part on the channel estimation information and a first channel condition prediction associated with the first sub-slot; and
receiving, from the first wireless device during a second sub-slot within the second time slot, one or more second transmissions precoded according to a second precoder that is based at least in part on the channel estimation information and a second channel condition prediction associated with the second sub-slot.

26. The method of claim 25, further comprising:
receiving, from the first wireless device, an indication of a quantity of precoders associated with transmissions from the first wireless device to the first wireless device during the second time slot, wherein the indicated quantity of precoders is equal to a quantity of sub-slots within the second time slot.

27. The method of claim 26, wherein a boundary between the first sub-slot and the second sub-slot is based at least in part on the quantity of precoders, the boundary being between an end symbol of the first sub-slot and a start symbol of the second time slot.

28. The method of claim 27, further comprising:
receiving, from the first wireless device, an indication of the boundary between the first sub-slot and the second sub-slot.

29. The method of claim 25, wherein multiple precoders being associated with transmissions during the second time slot is based at least in part on a velocity of the second wireless device satisfying a threshold velocity, the multiple precoders comprising the first precoder and the second precoder, and the transmissions during the second time slot comprising the one or more first transmissions and the one or more second transmissions.

30. The method of claim 25, further comprising:
transmitting, to the first wireless device, capability information indicating support by the second wireless device for communicating in accordance with two or more precoders within a slot, wherein the one or more first transmissions are precoded according to the first precoder and the one or more second transmissions are precoded according to the second precoder based at least in part on the capability information.
